(19) United States
(12) Patent Application Publication
(10) Pub. No.: US 2013/0059736 A1
(43) Pub. Date: Mar. 7, 2013

(54) METHODS AND COMPOSITIONS FOR PROFILING RNA MOLECULES

(71) Applicants: David Galas, Seattle, WA (US); Aimee Dudley, Seattle, WA (US); Kai Wang, Bellevue, WA (US)

(72) Inventors: David Galas, Seattle, WA (US); Aimee Dudley, Seattle, WA (US); Kai Wang, Bellevue, WA (US)

(73) Assignee: Institute for Systems Biology, Seattle, WA (US)

(21) Appl. No.: 13/576,926

(22) PCT Filed: Feb. 4, 2011
(86) PCT No.: PCT/US2011/023814

§ 371 Date: Nov. 14, 2012

Related U.S. Application Data
(60) Provisional application No. 61/301,816, filed on Feb. 5, 2010.

(51) Int. Cl. C40B 20/00; C40B 40/06; C40B 30/04

(52) U.S. Cl. 506/2; 506/9; 506/16

(57) ABSTRACT

Disclosed are compositions and methods for detecting target RNA molecules. A specialized DNA probe can be used to form RNA/DNA hybrids with target RNA molecules. Separation of the RNA/DNA hybrids increases the ease and sensitivity of detection and quantitation of the target RNA molecules.

### CROSS-REFERENCE TO RELATED APPLICATION

This application claims priority from U.S. provisional application 61/301,816 filed 5 Feb. 2010. The contents of this document are incorporated herein by reference.

### STATEMENT REGARDING FEDERALLY SPONSORED RESEARCH

This invention was made with government support under National Institutes of Health (NHGRI) Grant No. K22 HG002908 and National Science Foundation FIBR Grant No. EF-0527023. The government has certain rights in the invention.

### TECHNICAL FIELD

The disclosed invention is generally in the field of nucleic acid detection and quantification and specifically in the area of detecting, quantitating and/or sequencing RNA molecules.

### BACKGROUND ART

The accurate abundance measurement of the many hundreds or thousands of RNA species in biological samples is difficult to achieve. For example, the accurate measurement of 22-24 nucleotide long microRNA molecules is particularly difficult. These difficulties arise from several sources. First, the uniform hybridization properties required for accurate measurement by DNA-based microarray are significantly confounded by factors such as Tm and secondary structure in sequences of this length (Hughes, et al. (2001) Expression profiling using microarrays fabricated by an ink jet oligonucleotide synthesizer. Nat Biotechnol. 19:342-347). This highly constrained sequence space also severely limits (or prevents) the design of alternative probes in cases where the sequence is not conducive to detection by microarray or quantitative PCR based methods. Finally, short sequences are more sensitive to sequence alterations, such as genetic polymorphisms, splicing, or RNA editing.

### DISCLOSURE OF THE INVENTION

Disclosed are compositions and methods for detecting target RNA molecules. A specialized DNA probe can be used to form RNA/DNA hybrids with target RNA molecules. Separation of the RNA/DNA hybrids increases the ease, specificity, and sensitivity of detection of the target RNA molecules. The target RNA molecules can be detected directly or indirectly by detection and/or quantitation of the separated DNA probe.

The disclosed methods can involve bringing into contact an RNA sample and an excess of a target DNA probe for each target RNA molecule to be detected, separating target DNA probes hybridized to target RNA molecules from the sample, and detecting one or more of the separated target DNA probes. Some or all of the target DNA probes can comprise a first signature sequence, a target complement sequence, a second signature sequence, and at least one nucleotide-based bar code. The target complement sequence can be complementary to sequence in a target RNA molecule.

Disclosed are methods of detecting target RNA molecules, the method comprising (a) bringing into contact an RNA sample and an excess of a target DNA probe for each target RNA molecule to be detected, wherein at least one of the target DNA probes comprises a first signature sequence, a target complement sequence, a second signature sequence, and at least one nucleotide-based bar code, wherein the target complement sequence is complementary to sequence in a target RNA molecule, (b) separating target DNA probes hybridized to target RNA molecules from the remaining (unhybridized) DNA probes, and (c) detecting one or more of the separated target DNA probes are indicative of the presence of the corresponding target RNA molecules.

Also disclosed are methods of detecting target RNA molecules further comprising, prior to detecting the separated target DNA probes, the separated target DNA probes are amplified using primers corresponding to the first and second signature sequences, where the amplified target DNA probes are detected.

Also disclosed are sets of target DNA probes, wherein at least one of the target DNA probes comprises a first signature sequence, a target complement sequence, a second signature sequence, and at least one nucleotide-based bar code, wherein the target complement sequence is complementary to sequence in a target RNA molecule.

The target complement sequence can be disposed in the target DNA probe between the first signature sequence and the second signature sequence. The target complement sequence can be disposed in the at least one of the target DNA probes between the first signature sequence and the second signature sequence.

A plurality of target DNA probes can be brought into contact with the RNA sample. Each of the plurality of target DNA probes can be for a different target RNA molecule. The RNA sample can comprise RNA derived from biological materials. For example, the biological material can comprise cells, tissues, biological fluids, extracellular solutions, extracellular matrices, synthetic biological materials, or a combination. In the case of biological fluids, extracellular solutions, extracellular matrices, and the like, RNA can have been released into the biological fluids, extracellular solutions, extracellular matrices, and the like. In addition to RNA, the sample can contain other components such as DNA, proteins, metabolites, etc. For example, the RNA sample can comprise DNA, RNA, or both.

The disclosed methods can use multiple different target DNA probes. For example, at least 100 different target DNA probes can be brought into contact with the RNA sample, at least 1000 different target DNA probes can be brought into contact with the RNA sample, at least 10,000 different target DNA probes can be brought into contact with the RNA sample, or at least 100,000 different target DNA probes can be brought into contact with the RNA sample. Unless the context clearly indicates otherwise, reference to multiple target DNA probes refers to multiple different target DNA probes where the different target DNA probes have some difference in structure. Generally, the different target DNA probes will differ in nucleotide sequence from each other.

In some forms of the disclosed methods and sets, each of the target DNA probes for a different target RNA molecule can have a different nucleotide-based bar code. In some forms of the disclosed methods and sets, each of the target DNA probes for a different target RNA molecule can have at least one different nucleotide-based bar code. In some forms of the disclosed methods and sets, each of the target DNA probes that corresponds to a different RNA sample can have a different nucleotide-based bar code. In some forms of the disclosed methods and sets, each of the target DNA probes that corresponds to a different RNA sample can have at least one different nucleotide-based bar code. In some forms of the disclosed methods and sets, at least one of the target DNA probes can comprise a single nucleotide-based bar code. The target DNA probe can comprise a first nucleotide-based bar code and a second nucleotide-based bar code. In some forms of the disclosed methods and sets, at least one of the target DNA probes can comprise a first nucleotide-based bar code and a second nucleotide-based bar code.

In some forms of the disclosed methods and sets, each of the target DNA probes for a different target RNA molecule can have a different combination of nucleotide-based bar codes. In some forms of the disclosed methods and sets, each of the target DNA probes that corresponds to a different RNA sample can have a different combination of nucleotide-based bar codes. Two or more of the target DNA probes can correspond to different RNA samples, wherein each of the target DNA probes corresponding to a different RNA sample can have a different nucleotide-based bar code.

Two or more of the target DNA probes can correspond to different RNA samples, wherein both nucleotide-based bar codes of each of the target DNA probes corresponding to a different RNA sample can be different from the nucleotide-based bar codes of the other target DNA probes. Two or more of the target DNA probes can correspond to different RNA samples, wherein each of the target DNA probes corresponding to a different RNA sample can have a different combination of nucleotide-based bar codes.

At least one nucleotide-based bar code can be disposed in the target DNA probe between the first signature sequence and the target complement sequence. At least one nucleotide-based bar code can be disposed in the at least one of the target DNA probes between the first signature sequence and the target complement sequence. At least one nucleotide-based bar code can be disposed in the target DNA probe between the target complement sequence and the second signature sequence. At least one nucleotide-based bar code can be disposed in the at least one of the target DNA probes between the target complement sequence and the second signature sequence

The first nucleotide-based bar code can be disposed in the target DNA probe between the first signature sequence and the target complement sequence and the second nucleotide-based bar code can be disposed in the target DNA probe between the target complement sequence and the second signature sequence. The first nucleotide-based bar code can be disposed in the at least one of the target DNA probe between the first signature sequence and the target complement sequence and the second nucleotide-based bar code can be disposed in the at least one of the target DNA probe between the target complement sequence and the second signature sequence. In addition, one or more nucleotide-based bar codes can be adjacent to each other in the target DNA probe. For example, the first nucleotide-based bar code can be adjusted to the second nucleotide-based bar code.

Both nucleotide-based bar codes of each of the target DNA probes for a different target RNA molecule can be different from the nucleotide-based bar codes of the other target DNA probes. Both nucleotide-based bar codes of each of the target DNA probes that corresponds to a different RNA sample can be different from the nucleotide-based bar codes of the other target DNA probes.

At least one of the target DNA probes can comprise a detection sequence. At least one of the target DNA probes can comprise a second detection sequence. The detection sequence can be part of one of the signature sequences, between both of the signature sequences, or both. In some forms of the disclosed methods and sets, each of the target DNA probes can comprise a detection sequence, wherein the detection sequence can be part of one of the signature sequences, between both of the signature sequences, or both.

Detecting one or more of the target DNA probes can be accomplished using a primer corresponding to the detection sequence. Detecting one or more of the target DNA probes can be accomplished using a primer corresponding to the detection sequence and a primer corresponding to the second detection sequence. Detecting one or more of the target DNA probes can be accomplished by detecting one or more of the target DNA probes using a primer corresponding to the detection sequence. Detecting one or more of the target DNA probes can be accomplished by detecting one or more of the target DNA probes using a primer corresponding to the detection sequence and a primer corresponding to the second detection sequence. Detecting one or more of the target DNA probes can be accomplished by sequencing one or more of the target DNA probes using a primer corresponding to the detection sequence. Detecting one or more of the target DNA probes can be accomplished by sequencing one or more of the target DNA probes using a primer corresponding to the detection sequence and a primer corresponding to the second detection sequence.

In some forms, the disclosed methods can further comprise, prior to bringing into contact an RNA sample and the target DNA probes, (i) bringing into contact the RNA sample and a set of subtraction DNA probes, wherein the subtraction DNA probes in the set collectively can comprise sequences complementary to sequence of RNA molecules to be removed from the sample, and (ii) separating subtraction DNA probes hybridized to RNA molecules from the sample.

Subtraction DNA probes hybridized to RNA molecules can be separated from the sample by enriching for RNA/DNA hybrids. RNA/DNA hybrids can be enriched using a specific binding agent specific for RNA/DNA hybrids. At least one of the RNA molecules to be removed can be related to at least one of the target RNA molecules. At least one of the RNA molecules to be removed can be a variant form of at least one of the target RNA molecules. At least one of the RNA molecules to be removed can be a variant form of at least one of the target RNA molecules, wherein the variant form can be more common than the at least one of the target RNA molecules. The variant form to be removed can be a splice variant.

The target DNA probes hybridized to target RNA molecules can be separated from the RNA sample using a physical property of RNA/DNA hybrids, an enzymatic property of RNA/DNA hybrids, a specific binding agent specific for RNA/DNA hybrids, an enzymatic agent specific for RNA/DNA hybrids, or a combination. The target DNA probes hybridized to target RNA molecules can be separated from the sample by enriching for RNA/DNA hybrids. RNA/DNA hybrids can be enriched using a specific binding agent specific for RNA/DNA hybrids.

The specific binding agent can be conjugated to a solid substrate. The specific binding agent can be directly conjugated to the solid substrate. The specific binding agent can be indirectly conjugated to the solid substrate. The solid substrate can comprise tubes, slides, or beads. The beads can be in a column. Separating target DNA probes hybridized to target RNA molecules from the RNA sample can be accomplished by separating the solid substrate from the RNA sample.

Separating target DNA probes hybridized to target RNA molecules from the RNA sample can be accomplished by passing the RNA sample over a capture substrate comprising capture molecules, wherein the capture molecules can bind the specific binding agent. The capture substrate comprising capture molecules can be a column. The capture molecule can comprise biotin, avidin, streptavidin, NeutrAvidin®, or anti-antibody antibody. The specific binding agent can comprise an antibody specific for RNA/DNA hybrids. The antibody can comprise a capture molecule. The capture molecule can comprise biotin, avidin, streptavidin, or NeutrAvidin®.

Separating target DNA probes hybridized to target RNA molecules from the sample can be accomplished by separating the antibody from the RNA sample. Separating target DNA probes hybridized to target RNA molecules from the sample can be accomplished by separating RNA/DNA hybrids bound to the antibody from the RNA sample, wherein separating the RNA/DNA hybrids bound to the antibody from the RNA sample can result in separation of the RNA molecules in the RNA/DNA hybrids from other RNA molecules in the RNA sample. Separating target DNA probes hybridized to target RNA molecules can be accomplished by mixing the antibody with the RNA sample after step (a), bringing into contact an RNA sample and an excess of a target DNA probe for each target RNA molecule to be detected, wherein at least one of the target DNA probes comprises a first signature sequence, a target complement sequence, a second signature sequence, and at least one nucleotide-based bar code, wherein the target complement sequence is complementary to sequence in a target RNA molecule.

The target DNA probes can be already hybridized to target RNA molecules when the antibody is mixed with the RNA sample. The antibody can be conjugated to a solid substrate. The solid substrate can comprise tubes, slides, or beads. The beads can be in a column.

Separating the antibody from the RNA sample can be accomplished by passing the RNA sample over a capture substrate comprising capture molecules, wherein the capture molecules can bind the antibody. The capture substrate comprising capture molecules can be a column. The capture molecule can comprise biotin, avidin, streptavidin, NeutrAvidin®, or anti-antibody antibody. The capture molecule can be conjugated to a solid substrate. The solid substrate can comprise tubes, slides, or beads. The beads are in a column. Separating target DNA probes hybridized to target RNA molecules from the sample can be accomplished by passing the RNA sample over a solid substrate conjugated with the antibody.

Detecting one or more of the target DNA probes can be accomplished by sequencing one or more of the target DNA probes which can be accomplished by Solexa™ sequencing, by SOLiD™ sequencing, using Illumina® Genome Analyzer™, using 454™, or a combination.

The target RNA molecules can comprise microRNA molecules. The target RNA molecules can comprise mRNA molecules. The target RNA molecules can comprise noncoding RNA molecules. The target RNA molecules can comprise variant sequences. The target RNA molecules can comprise variant sequences resulting from the presence of DNA polymorphisms. The target RNA molecules can comprise splice variations. The target RNA molecules can comprise sequences resulting from RNA editing.

In some forms, the disclosed methods can further comprise identifying one or more nucleotide-based bar codes in the sequence of the one or more of the target DNA probes. The identity of the one or more nucleotide-based bar codes can identify the target RNA molecules that correspond to the one or more nucleotide-based bar codes. The identity of the one or more nucleotide bar codes can identify the RNA samples that correspond to the identified target RNA molecules. The one or more bar codes can be identified via the detection and/or quantification of the target DNA probes, wherein the detection and/or the quantitation of the target DNA probes is sequence-specific.

In some forms, the disclosed methods can further comprise identifying one or more of the target complement sequences in the sequence of the one or more of target DNA probes. The one or more target complement sequences can be identified via the detection and/or quantitation of the target DNA probes, wherein the detection and/or quantitation of the target DNA probes is sequence-specific. The identity of the one or more target complement sequences can identify the target RNA molecules that correspond to the one or more target complement sequences. The identity of the one or more target complement sequences can identify the RNA samples that correspond to the identified target RNA molecules. The one or more target complement sequences can be identified via the detection and/or quantitation of the target DNA probes, wherein the detection and/or quantitation of the target DNA probes is sequence-specific.

In some forms of the disclosed methods and sets, each of the target DNA probes can be for a different target RNA molecule. For example, there can be at least 100 different target DNA probes. There can be at least 1000 different target DNA probes. There can be at least 10,000 different target DNA probes. There can be at least 100,000 different target DNA probes.

The target RNA molecules can comprise microRNA molecules, mRNA, noncoding RNA, variant RNA sequence, variant RNA sequences resulting from the presence of DNA polymorphisms, variant RNA sequences resulting from the splice variations, RNA sequences resulting from RNA editing, or a combination.

Additional advantages of the disclosed method and compositions will be set forth in part in the description which follows, and in part will be understood from the description, or may be learned by practice of the disclosed method and compositions. The advantages of the disclosed method and compositions will be realized and attained by means of the elements and combinations particularly pointed out in the appended claims. It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the disclosed method and compositions and together with the description, serve to explain the principles of the disclosed method and compositions.

FIG. 1 is a schematic outline of some form of the disclosed methods. A. The structure of a DNA molecule in the population that contains the complement of the RNA molecules to be measured. A few bases were included on either end of the sequence in order to accommodate variations in the positions of the ends of the miRNA caused by variation in the processing. The DNA molecules also contain a molecular “bar code” to facilitate the mixing of different RNA samples as well as sequences (primers 1 and 2) that facilitate amplification and sequencing by high-throughput sequencing platforms. (b=bases or nucleotides) B. The elements of the steps of the process. It is a requirement that the DNA molecules outnumber the RNA molecules in each sequence category so that the number of hybrids corresponds to the number of input RNA molecules (i.e., a given DNA molecule is present in molar excess of its RNA target thereby allowing a quantitative assessment of a given RNA species that is not limited by saturation).

FIG. 2 is a diagram of a scheme for subtraction of specific sequences from the sample RNA population. The diagram shows a single subtraction, but the process can be carried out several times in succession, if required. The remaining RNA population is treated in the same fashion as above, as shown.

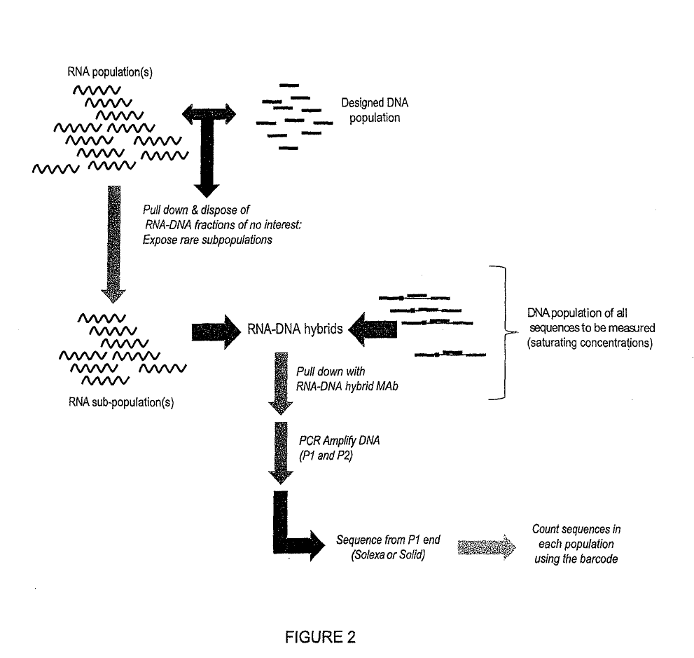

FIG. 3 shows a diagram of the capture oligos which contain sequences that will permit cluster generation and sequencing on the Solexa™ platform (Solexa™ A, sequencing primer, and Solexa™ B), a 4 bp barcode for sample tracking, and regions capable of hybridizing two yeast RNA sequences (PHO88 or GAL7) or artificial sequence that are not present in the yeast genome (YNS1 and YNS2).

### DETAILED DESCRIPTION OF THE INVENTION

The disclosed method and compositions may be understood more readily by reference to the following detailed description of particular embodiments and the Example included therein and to the Figures and their previous and following description.

Disclosed are compositions and methods for detecting target RNA molecules. The disclosed methods can involve bringing into contact an RNA sample and an excess of a target DNA probe for each target RNA molecule to be detected, separating target DNA probes hybridized to target RNA molecules from the sample, and detecting one or more of the separated target DNA probes. Some or all of the target DNA probes can comprise a first signature sequence, a target complement sequence, a second signature sequence, and at least one nucleotide-based bar code. The target complement sequence can be complementary to sequence in a target RNA molecule.

Disclosed are methods of detecting target RNA molecules, the method comprising (a) bringing into contact an RNA sample and an excess of a target DNA probe for each target RNA molecule to be detected, wherein at least one of the target DNA probes comprises a first signature sequence, a target complement sequence, a second signature sequence, and at least one nucleotide-based bar code, wherein the target complement sequence is complementary to sequence in a target RNA molecule, (b) separating target DNA probes hybridized to target RNA molecules from the sample, and (c) detecting one or more of the separated target DNA probes, where in the detected target DNA probes are indicative of the presence of the corresponding target RNA molecules.

Also disclosed are methods of detecting target RNA molecules further comprising, prior to detecting the separated target DNA probes, the separated target DNA probes are amplified using primers corresponding to the first and second signature sequences, where the amplified target DNA probes are detected. Also disclosed are methods of detecting target RNA molecules further comprising, prior to bringing into contact an RNA sample and the target DNA probes, (i) bringing into contact the RNA sample and a set of subtraction DNA probes, wherein the subtraction DNA probes in the set collectively can comprise sequences complementary to sequence of RNA molecules to be removed from the sample, and (ii) separating subtraction DNA probes hybridized to RNA molecules from the sample.

Also disclosed are sets of target DNA probes, wherein at least one of the target DNA probes comprises a first signature sequence, a target complement sequence, a second signature sequence, and at least one nucleotide-based bar code, wherein the target complement sequence is complementary to sequence in a target RNA molecule.

It is to be understood that the disclosed method and compositions are not limited to specific synthetic methods, specific analytical techniques, or to particular reagents unless otherwise specified, and, as such, may vary. It is also to be understood that the terminology used herein is for the purpose of describing particular embodiments only and is not intended to be limiting.

### Methods

The disclosed methods provide a robust and highly adaptable way to detect and measure any number of target nucleic acid sequences. The methods can be adapted to detect a large number of target sequences in a single assay. For example, entire transcriptomes can be analyzed in a single assay of the disclosed methods. The disclosed methods can also be adapted for high-throughput and ultra high-throughput processing, detection, quantitation, and/or sequencing systems. Rather than using traditional methods of detecting or sequencing sequence tags that are converted from biological samples, the disclosed methods use target RNA sequences from the biological samples as a “bait” to select out pre-synthesized gene/RNA specific tags in a stoichiometrical manner. This approach can greatly improve the throughput, simplify the sample preparation method, and remove significant amounts of bias that result from traditional sample preparation.

The disclosed methods can make use of methods for producing large, defined populations of DNA molecules (Tian, et al. (2004) Accurate multiplex gene synthesis from programmable DNA microchips. Nature 432: 1050-4; Agilent Technologies). Examples of such methods use microarray-based synthesis to accurately produce large numbers (tens to hundreds of thousands) of molecules that can be up to 200 nucleotides in length. Such methods can be used to produce large amounts of the disclosed target DNA probes.

Because the disclosed methods produce RNA/DNA hybrids that are separated from the sample source of the RNA, the disclosed methods can make use of high affinity, specific antibodies for RNA/DNA hybrids that are largely sequence non-specific. Examples of such antibodies include, for example, mouse monoclonal S9.6, antibodies described in U.S. Pat. Nos. 4,732,847 and 4,833,084, and antibodies in some Qiagen products and kits (Digene® HPV assay is based on such a MAb).

For identification of the separated target DNA probes produced in the disclosed methods, next generation methods for sequencing of DNA molecules can be used. These NextGen sequencing methods can produce millions of sequence reads in a single run, thus allowing the mass detection, quantitation, identification, and/or analysis of large numbers of target DNA probes. This can allow both sensitive detection and/or quantitation of rare sequences and accurate counting of populations of particular sequences. Examples of such NextGen sequencing systems include commercially available instruments such as Illumina® (Solexa™) and ABI SOLiD™.

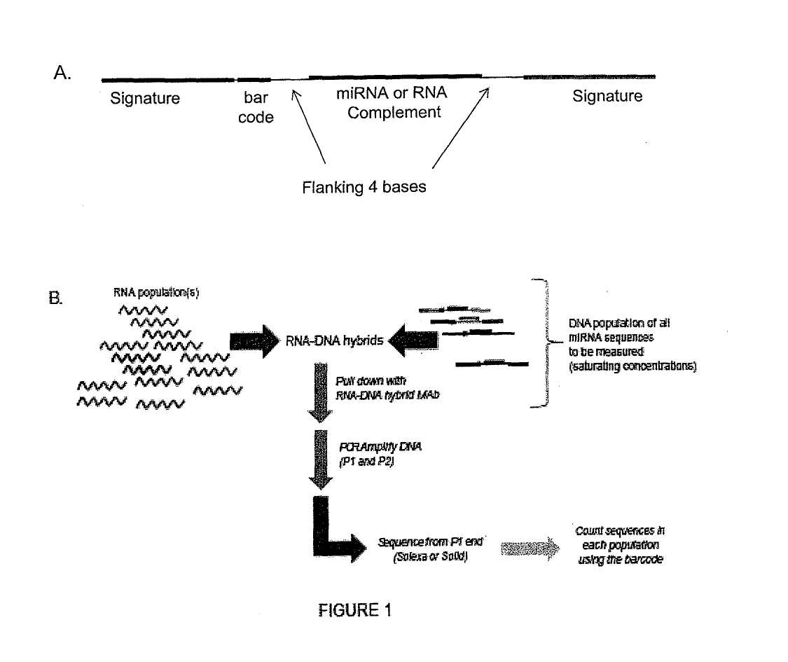

An example of the strategy of the disclosed methods is shown in FIG. 1. In this example, a DNA library (set of target DNA probes) is used that allows isolation of populations of immediately and uniformly amplifiable DNA molecules that can be detected, measured, sequenced, counted, etc., yielding an accurate measurement of the population of target RNA molecules. While depicted in the context of detecting small RNA molecules, such as microRNAs, the disclosed methods can be used for the detection, quantitation and/or measurement of any RNA molecules, such as mRNA, and, indeed, any nucleic acid sequence that can be converted or attached to RNA. The advantages of the disclosed methods are available for detection and/or quantitation of any of these various nucleic acid sequences. The disclosed methods are also useful for detecting rare RNA species (such as RNAs that contain edits, splices, or natural polymorphisms).

Unlike other methods for quantitating RNA transcripts (such as microarray, RT-PCR, or sequencing methods), the disclosed methods allow a readout of RNA abundance only one step from the original RNA population. As a result, the DNA molecule population selected out by the target RNA molecules present in a sample can be directly detected and analyzed, such as by introduction directly into the NextGen sequencing apparatus, without requiring reverse transcription, ligation, gel purification or PCR amplification steps. Such steps can bias the sample by altering the abundance of molecules in a sample and introducing artifactual sequences (through, for example, copying errors, ligation artifacts, and PCR errors). Thus, the disclosed method sidesteps many problems that can reduce the accuracy of detection and/or quantitation results. Furthermore, by using a sequence-based bar code in the design of target DNA probes (FIG. 1A), more than a thousand different target sequences, populations, or combinations (a number limited only by the length of the nucleotide-based bar code sequence) can be combined in a single assay and detected and counted separately. Thus, the disclosed methods allow the simultaneous detection quantitation and/or measurement of an almost arbitrarily large set of RNA samples and/or target RNA molecules. The size of the RNA population (that is, the number of different target RNA molecules) in each sample that can be measured is limited only by the diversity of the DNA sequences that can be synthesized, and the number of samples is limited only by the total capacity of the apparatus used (for example, for sequencing, the capacity of the sequencer, which can include the number of reads that can be achieved in a single run and the statistics of counting these reads). Finally, because the disclosed method eliminates a number of amplification and/or labeling steps (used in other detection and/or quantitation methods) that require expensive reagents (such as enzymes, modified nucleotides, kits, etc.) other methods, including current microarray or NextGen sequencing based methods, the disclosed methods can be implemented with less cost and complexity.

The disclosed methods can be used for a variety of purposes. For example, the disclosed methods can be used to detect one or more target RNA molecules, to measure the amount, level, concentration, expression, etc. of one or more target RNA molecules, to profile, map, fingerprint, etc. the presence, amount, level, concentration, expression, etc. of one or more target RNA molecules, and to compare, track, or analyze changes or difference in the presence, amount, level, concentration, expression, etc. of one or more target RNA molecules. The disclosed methods can be used to detect or measure any one or more particular nucleic acid sequences or molecules, any one or more particular classes or types of nucleic acid sequence or molecule, or any combination of one or more particular nucleic acid sequences or molecules and any one or more particular classes or types of nucleic acid sequence or molecule. For example, target RNA molecules for particular cells, tissues, disease states, organisms, etc. can be detected or measured. In particular, target RNA molecules from or characteristic of microorganisms, bacteria, viruses, etc. can be detected and measured. Target RNA molecules from or characteristic of pathogens can be detected or measured.

Some of these uses can be facilitated by performing the disclosed methods in a multiplex manner. For example, target DNA probes can include signature sequences and nucleotide-based bar codes that can be used to distinguish different target DNA probes. Such tags can be used to designate the target complement sequence in (and thus the target of) the target DNA probe, the context in which the target DNA probe is used, or a combination. For example, a unique nucleotide-based bar code can be used for each target DNA probe designed for a different target. Identification of the nucleotide-based bar code corresponding to a given target DNA probe thus identifies the target DNA probe. Of course, the target complement sequence itself can be used as a tag for identifying different target DNA probes in a multiplex context. However, use of nucleotide-based bar codes for tagging target DNA probes allows the selection of arbitrary sequences that can be designed to be, for example, easily distinguished, detectable under standard conditions, or both. Similarly, by using signature sequences for priming, probing, detection, quantitating, etc. of target DNA probes, the sequence of the signature sequences can be designed to be, for example, easily distinguished, usable under standard conditions, or both.

An example of a use of the disclosed methods is for global mRNA analysis. For this use, for example, tag(s) (such as nucleotide-based bar codes or signature sequences) corresponding to each gene can be designed and incorporated into target DNA probes in the set of target DNA probes (FIG. 1A). This would allow detection, quantitation and/or measurement of the entire transcriptome directly based on a pre-made library (set) of target DNA probes, complementary to each molecule in the transcriptome. Many other similar uses of complete or targeted libraries and sets of target DNA probes can be used.

Another example of a use of the disclosed methods is for detecting/measuring RNA sequences from pathogen. For this use, for example, one or more target DNA probes could be designed for unique or characteristic sequences of the pathogen. A multiplex form of this method can be used to detect in one assay too presence or level of numerous pathogens. Another form of this method could be used to detect or monitor a change in a microorganism or pathogen by designing target DNA probes for sequences associated with relevant states of the microorganism. For example, the method could be used to detect/monitor the transition of drug sensitive pathogens to drug resistant pathogens or reactivation of latent viruses.

Low cost, ultra high-throughput (NextGen) sequencing technologies (for example, ABI SOLiD™ or Illumina® Genome Analyzer™) offer potentially powerful methods for measuring the levels of RNA molecules. Until the disclosed methods, NextGen sequencing was the best available method for measuring RNA expression on an absolute scale, a type of information that can facilitate the characterization of threshold- and gradient-based regulatory switches, analysis of codon adaptation indices, quantitative prediction of transcription factor effects on promoters, analysis of translational efficiency, measurement of promoter strength, and cross-species comparisons (Dudley, et al. (2002) Measuring absolute expression with microarrays using a calibrated reference sample and an extended signal intensity range. PNAS 99:7554-9). However, the numerous steps required to convert an RNA sample into a sequenceable library compatible with current NextGen sequencing machines add significant cost and potential bias to the results. The disclosed methods, which make use of a simple, high throughput sample preparation method, provide an alternative that can avoid many of these problems and can provide non-biased results.

A. Separation

Separation of the hybridized target DNA probes can be accomplished in any suitable manner. For example, target DNA probes hybridized to target RNA molecules can be separated using specific binding agents specific for RNA/DNA hybrids. As another example, the target DNA probes can be coupled or conjugated to a specific binding agent or capture molecule that allows selective removal of the target DNA probes based on the specific binding agent or capture molecule. The target DNA probes can also be attached to or captured on a solid substrate that has one or more properties that allow separation. For example, the target DNA probes that have hybridized to an RNA molecule can be attached to or captured on magnetic beads, which then can be separated by application of a magnetic field. Separation can be considered a form of enrichment and some forms of enrichment can be separations. Thus, separation and enrichment, especially in the context of target DNA probes and RNA/DNA hybrids generally can be used interchangeably. A major advantage of the approach of the disclosed methods is that they are highly robust to the presence of non-specific molecules that come through the enrichment step. So long as those molecules do not contain sequences that allow them to be detected by the detection method, they will not interfere with the disclosed methods. For example, the contamination of the RNA sample by single stranded RNA or genomic DNA without sequences that are all required in order to detect the molecules will not contribute background levels of those sequences to the results. For example, the contamination of the RNA sample by single stranded RNA or genomic DNA without sequences complementary to the Solexa™/Illumina® amplification and sequencing sequences will not contribute background levels of those sequences to the results when using Solexa™/Illumina® sequencing.

Separation based on RNA/DNA hybrids is particularly useful both because the formation of target RNA/DNA hybrids can be sequence-specific (and thus target-discriminating) and because non-target RNA/DNA hybrids will be rare in most samples compared with singled stranded DNA and RNA, double stranded DNA, DNA/DNA hybrids, and RNA/RNA hybrids. The level of enrichment of target RNA and of elimination of potentially interfering non-target nucleic acid molecules results in a method that is sensitive, discriminating, and accurate.

Separation based on RNA/DNA hybrids can use any useful feature of the RNA/DNA hybrids. For example, RNA/DNA hybrids can be separated based on a physical property of the RNA/DNA hybrid, an enzymatic property of the RNA/DNA hybrid, or both. A physical property of an RNA/DNA hybrid can be, for example, a chemical property such as the base pairing of deoxyribonucleotides to ribonucleotides. An enzymatic property of an RNA/DNA hybrid can be, for example, the suitability of the RNA/DNA hybrid to be a substrate of particular enzymes or to be resistant to particular enzymes. The target DNA probes hybridized to target RNA molecules can be separated using an enzymatic agent specific for RNA/DNA hybrids.

The target DNA probes hybridized to target RNA molecules can be separated using a specific binding agent specific for RNA/DNA hybrids. The target DNA probes hybridized to target RNA molecules can be separated from the sample by enriching for RNA/DNA hybrids. The RNA/DNA hybrids can be enriched using a specific binding agent specific for RNA/DNA hybrids.

The specific binding agent used for separation or enrichment can be conjugated to a solid substrate. For example, separating target DNA probes hybridized to target RNA molecules from the RNA sample can be accomplished by separating a solid substrate (to which the hybrids are bound or conjugated) from the RNA sample. As another example, separating target DNA probes hybridized to target RNA molecules from the RNA sample can be accomplished by passing the RNA sample over a capture substrate comprising capture molecules, where the capture molecules bind a specific binding agent (to which the hybrids are bound). Passing a first component (such as an RNA sample) over another component (such as a solid substrate or a capture substrate) refers to mixing or bringing into contact the first and second components and letting the first component to leave contact with the second component. In most cases of passing over, it will be with the understanding that some part of the first component may or is intended to remain in contact with the second component. Thus, for example, passing a solution containing an analyte over an affinity column for that analyte will result in the solution first coming into contact with the column and then leaving contact with the column, while the analyte binds to the column and remains bound.

As another example, separating target DNA probes hybridized to target RNA molecules from the sample can be accomplished by separating an antibody (to which the hybrids are bound) from the RNA sample. As another example, separating target DNA probes hybridized to target RNA molecules from the sample can be accomplished by separating RNA/DNA hybrids bound to an antibody from the RNA sample. In such a case, for example, separating the RNA/DNA hybrids bound to the antibody from the RNA sample results in separation of the RNA molecules in the RNA/DNA hybrids from other RNA molecules in the RNA sample. As another example, separating target DNA probes hybridized to target RNA molecules can be accomplished by mixing an antibody (specific for RNA/DNA hybrids) with the RNA sample after mixing the target DNA probes and the sample. In such a case, for example, the target DNA probes can already be hybridized to target RNA molecules when the antibody is mixed with the RNA sample. As another example, separating the antibody from the RNA sample can be accomplished by passing the RNA sample over a capture substrate comprising capture molecules, where the capture molecules bind an antibody (to which the hybrids are bound). As another example, separating target DNA probes hybridized to target RNA molecules from the sample can be accomplished by passing the RNA sample over a solid substrate conjugated with an antibody (to which the hybrids are bound).

B. Detection

Any analyte, including the various compounds and compositions disclosed herein, can be detected. For example, target DNA probes, target RNA molecules, signature sequences, nucleotide-based bar codes, and detection sequences can be detected. Detection of analytes can be by, for example, detecting the level, amount, presence, or a combination, of the analyte in a sample or assay. Detection of the disclosed compounds and compositions can be accomplished in any of a variety of ways and using any of a variety of techniques. Many such detection techniques are known and can be readily adapted for use in the disclosed methods. In most cases, the disclosed methods do not depend on particular techniques of detection. However, certain techniques and reagents are useful for detecting different types of compounds an compositions. Those of skill in the art are aware of the selection of particular techniques for the detection of particular compounds and compositions. Detection can, but need not, involve an element of quantitation.

Detection can be of a class of compounds or compositions or of specific compounds or compositions. Although the disclosed methods generally involve detection of specific compounds and compositions, such as specific target RNA molecules, the disclosed methods can also be used to detect classes or groups of compounds or compositions, generally via one or more common properties. In other forms, multiple different specific compounds and/or compositions can be detected. Such detection accomplished in the same assay or run (or in separate assays of runs performed at the same time), can generally be referred to as multiplex detection.

Detection can involve or include, for example, measuring, sequencing, identification, or a combination. Measurement is useful for determining abundances and levels of an analyte in a sample. Sequencing is useful for identifying nucleic acid sequence and molecules. Uses and forms of detection in the context of the disclosed methods are also described elsewhere herein.

Detection can involve a variety of forms. For example, detecting one or more of the target DNA probes can be accomplished using a primer corresponding to the detection sequence, detecting one or more of the target DNA probes can be accomplished using a primer corresponding to the detection sequence and a primer corresponding to the second detection sequence, detecting one or more of the target DNA probes can be accomplished by detecting one or more of the target DNA probes using a primer corresponding to the detection sequence, detecting one or more of the target DNA probes can be accomplished by detecting one or more of the target DNA probes using a primer corresponding to the detection sequence and a primer corresponding to the second detection sequence, detecting one or more of the target DNA probes can be accomplished by sequencing one or more of the target DNA probes using a primer corresponding to the detection sequence, and detecting one or more of the target DNA probes can be accomplished by sequencing one or more of the target DNA probes using a primer corresponding to the detection sequence and a primer corresponding to the second detection sequence.

1. Quantitating and Measuring

Any analyte, including the various compounds and compositions disclosed herein, can be detected by quantitating and/or measuring, for example, the level, amount, presence, or a combination, of the analyte in a sample or assay. For example, target DNA probes, target RNA molecules, signature sequences, nucleotide-based bar codes, and detection sequences can be quantitated and/or measured. Measurement of the level, amount, presence, or a combination, of the analyte can constitute and/or result in quantitation of the analyte. Similar to detection, measurement of the disclosed compounds and compositions can be accomplished in any of a variety of ways and using any of a variety of techniques. Many such measurement techniques are known and can be readily adapted for use in the disclosed methods. In most cases, the disclosed methods do not depend on particular techniques of measurement. Measurement can involve an element of quantitation.

Many techniques are known for measuring abundances and levels of an analyte in a sample, such techniques can be adapted for use with the disclosed methods. For the detection of RNA molecules, measurement of the abundances and levels of target RNA molecules in an RNA sample can be particularly useful because the abundance and level of RNA molecules can be significant both as a cause or as an effect of cell and tissue states and development. For this purpose, accurate and consistent measurement of the abundances and levels of RNA molecules can provide more accurate and meaningful results. The disclosed methods are particularly suited to providing such accurate and consistent measurements. As an example, some forms of the disclosed method reduce or eliminate sequence bias in measurement of RNA molecules in a sample.

2. Sequencing

Nucleic acid sequences and molecules can be detected, measures, identified, and so on, via sequencing. In the context of nucleic acid sequences and molecules, sequencing refers to the determination or identification of some or all of the nucleotide base sequence of a nucleic acid sequence or molecule. Numerous techniques for nucleic acid sequencing are known and can be used with the disclosed methods. Examples of useful types of sequencing techniques include techniques involving detection of individual nucleotide bases (such as by detection of terminated primer extension products) and detection of multiple nucleotide bases (such as by hybridization of probes of known sequence). Any suitable sequencing technique can be used with the disclosed methods. Sequencing is particularly useful for identifying nucleic acid sequences and molecules.

Particularly useful sequencing techniques are those that can generate large amounts of sequence data quickly and accurately. High-throughput and ultra-high throughput sequencing provides a number of advantages, the main two being faster results and the ability to detect and measure a large number of nucleic acid molecules. Examples of useful high-throughput sequencing techniques include Solexa™ sequencing, SOLiD™ sequencing, and sequencing using a Illumina® Genome Analyzer™ or a 454™.

Illumina® Sequencing technology is based on massively parallel sequencing of millions of fragments using reversible terminator-based sequencing chemistry. Illumina® Sequencing technology relies on the attachment of randomly fragmented genomic DNA to a planar, optically transparent surface. Attached DNA fragments are extended and bridge amplified to create an ultra-high density sequencing flow cell with hundreds of millions of clusters, each containing ˜1,000 copies of the same template. These templates are sequenced using a four-color DNA sequencing-by-synthesis technology that employs reversible terminators with removable fluorescent dyes. This allows high accuracy and true base-by-base sequencing, eliminating sequence-context specific errors and enabling sequencing through homopolymers and repetitive sequences. High-sensitivity fluorescence detection is achieved using laser excitation and total internal reflection optics. Sequence reads are aligned against a reference genome and genetic differences are called using specially developed data analysis pipeline software.

The SOLiD™ System involves depositing beads containing template DNA fragments to be sequenced onto a glass slide. Primers hybridize to a sequence within the template. A set of four fluorescently labeled di-base probes compete for ligation to the sequencing primer. Specificity of the di-base probe is achieved by interrogating every 1st and 2nd base in each ligation reaction. Multiple cycles of ligation, detection and cleavage are performed with the number of cycles determining the eventual read length. Following a series of ligation cycles, the extension product is removed and the template is reset with a primer complementary to the n−1 position for a second round of ligation cycles. Five rounds of primer reset are completed for each sequence tag. Through the primer reset process, each base is interrogated in two independent ligation reactions by two different primers. For example, the base at read position 5 is assayed by primer number 2 in ligation cycle 2 and by primer number 3 in ligation cycle 1 (see figure at right). This dual interrogation is fundamental to the unmatched accuracy characterized by the SOLiD™ System.

The SOLiD™ System relies on open slide format and flexible bead densities to enable increases in throughput with protocol and chemistry optimizations. The SOLiD™ System provides system accuracy greater than 99.94%, due to 2 base encoding. 2 Base encoding enables unique error checking capability, providing higher confidence in each call. The SOLiD™ System can generate over 20 gigabases and 400M tags per run. The independent flow cell configuration of the SOLiD™ Analyzer™ two completely independent experiments in a single run. The combination of multiple slide configuration and sample multiplexing capability enables you to analyze multiple samples cost effectively for a variety of applications. The SOLiD™ System supports sample preparation for mate-paired libraries with insert sizes ranging from 600 bp up to 10 kbp. This broad range of insert sizes combined with ultra high throughput and flexible 2 flow cell configuration enables more precise characterization of structural variation across the genome.

3. Identification

In the context of the disclosed methods, identification refers to determination of the particular type or instance of a thing, such as of the disclosed target DNA probes, target RNA molecules, signature sequences, nucleotide-based bar codes, and detection sequences. Thus, for example, a target DNA probe can be identified by determining part of its sequence, where the sequence is characteristic of that target DNA probe. In the disclosed method, a number of components are, or can be designed, to correspond to, be complementary to, or be for particular other components. By such correspondence, identification of one component can often allow identification of any other components that correspond. For example, a target DNA probe can be designed with a target complement sequence that is complementary to a particular sequence of a microRNA of interest. The target DNA probe can be said to correspond to, or to be for, the microRNA of interest. When used in the disclosed methods, detection or identification of the target DNA probe can result in the detection of the presence, or identification, of the corresponding microRNA in the sample. Extending this example, if one of two different forms of this target DNA probe, each with the same target complement sequence but each having a different signature sequence, are used in two different samples, detection or identification of one of the signature sequences can result in the detection of the presence, or identification, of the corresponding microRNA in the sample corresponding to the target DNA probe having the detected signature sequence. Because the two forms of target DNA probe were used in different samples, each of the target DNA probes (and each of the signature sequences) corresponds to, or is for, only one of the samples. It is through this design and correspondence that the sample in which the target RNA was present can be determined in forms of the disclosed methods involving multiple different target DNA probes and multiple different samples.

C. Amplification

Some forms of the disclosed method can involve amplification of nucleic acids. For example, RNA molecules in a sample can be amplified prior to adding target DNA probes. As another example, DNA in a sample can be replicated or amplified as RNA molecules for use in the disclosed methods. As another example, target RNA molecules (or any subset of nucleic acids in a sample) can be selectively amplified.

Numerous procedures and techniques for amplification of nucleic acids are known and can be adapted for use in the disclosed methods. For example, nucleic acids can be amplified using PCR, single strand extension, transcription or other RNA polymerization.

D. Enrichment and Subtraction

Some forms of the disclosed method can involve enrichment of target RNA molecules prior to adding target DNA probes. This can be useful for increasing the sensitivity and accuracy of the detection, quantitation, and/or measuring of target RNA molecules. For example, if a sample includes many RNA molecules (and other nucleic acids) beside the target RNA molecule, it can be useful to reduce the amount of non-target RNA molecules prior to adding target DNA probes. This can reduce nonspecific and/or probe-depleting binding of the target DNA probes to non-target nucleic acids. Enrichment can be particularly useful where a sample contains or is suspected of containing non-target RNA molecules that are closely related to target RNA molecules. For example, if the target RNA molecule is a rare variant sequence of a more common RNA molecule, it can be useful to enrich for the variant target RNA molecule. As used herein, “related to” in the context of nucleic acid sequences and molecules refers to nucleotide sequences that are similar to each other. Thus, for example, variants of genes or RNA molecules are related to each other because their nucleotide sequences are similar to each other (usually being identical except for the variations). In this way, for example, an RNA molecule that is related to a target RNA molecule has some nucleotide sequence that is similar to the nucleotide sequence of the target RNA molecule. Thus, for example, RNA molecules to be removed can be related to target RNA molecules.

Sequence subtraction can be used in the disclosed methods and is particularly useful for measuring the level of rare RNA molecules such as edited or spliced, mutant or other variant forms. Sequence subtraction can be added to any form of the disclosed methods. In some forms, subtraction DNA probes having sequence complementary to are introduced to pull down RNA sequences in the population that are to be removed in order to increase the relative numbers of any rarer sequences that need to be measured, before the pull down for target RNA detection and/or quantitation is done. Sequence subtraction can be used, for example, to measure rare genetic variants in a population (due, for example, to somatic mutation as in cancer cells or fetal cells in the maternal blood stream), edited RNA molecules (as can occur in certain cell types in certain states), or rare RNA molecules resulting from aberrant or rare processing (cleavage, splicing etc.).

Examples of the use of sequence subtractions for the purpose of revealing minor fractions of RNA for better measurement include, for example, genetic variations that occur in the RNA (such as single base changes in the RNA sequence due to genetic differences in the genome), splice variations of any kind, and editing of RNA. For example, sequence subtraction can be used to remove the major population of spliced RNA and to allow the accurate measurement of minor variants, whether they are due to stochastic effects, minor cell populations or time dependent effects. Because the disclosed methods can easily discriminate a single base change (such as A to I, or A to G), RNA edits that occur in rare cell types, in short intervals of time etc., can be revealed by the subtraction process.

Sequence subtraction can involve bringing into contact an RNA sample and a set of subtraction DNA probes and separating subtraction DNA probes hybridized to RNA molecules from the sample. The subtraction DNA probes in the set can collectively comprise sequences complementary to sequence of RNA molecules to be removed from the sample. Collectively comprise means that all of the subtraction DNA probes taken together include the indicated sequences. Subtraction DNA probes hybridized to RNA molecules can be separated from the sample by enriching for RNA/DNA hybrids. The RNA molecules to be removed can be related to target RNA molecules. For example, at least one of the RNA molecules to be removed is related to at least one of the target RNA molecules, at least one of the RNA molecules to be removed can be a variant form of at least one of the target RNA molecules, at least one of the RNA molecules to be removed can be a variant form of at least one of the target RNA molecules. The variant form can be more common than the at least one of the target RNA molecules. By more common is meant that there are more molecules of the RNA molecule to be removed than of the related target RNA molecule in the sample or in the source of the sample. The variant form of RNA to be removed can be, for example, a splice variant.

Enrichment can be accomplished using any suitable technique, including by removing non-target nucleic acid molecules or by removing target RNA molecules. Enrichment can also be viewed as subtraction. Thus, for example, subtraction of unwanted nucleic acids can leave the target RNA molecules in the sample enriched. Similarly, by enriching for unwanted nucleic acid molecules in solution or medium to be discarded or set aside, the remaining solution or medium will have unwanted nucleic acid molecules subtracted (and target RNA molecules enriched). RNA/DNA hybrids are enriched when the amount, concentration, or both of the RNA/DNA hybrids is increased relative to the amount, concentration, or both of non-hybridized RNA molecules, DNA molecules, non-hybridized nucleic acids, non-target RNA molecules, and the like, or even any other components in a sample. Generally, any desired molecule or type or class of molecule can be selected as the RNA, nucleic acid, component, etc. against which RNA/DNA hybrid enrichment can be measured.

A useful form of enrichment involves bringing into contact the RNA sample and a set of subtraction DNA probes and separating subtraction DNA probes hybridized to RNA molecules from the sample. The subtraction DNA probes in the set can collectively comprise sequences complementary to sequence of RNA molecules to be removed from the sample. Separation of the hybridized subtraction DNA probes from the sample removes the hybridized RNA molecules from the sample and leaves the target RNA molecules enriched in the sample.

Separation of the hybridized subtraction DNA probes can be accomplished in any suitable manner. For example, subtraction DNA probes hybridized to RNA molecules can be separated using specific binding agents specific for RNA/DNA hybrids. As another example, the subtraction DNA probes can be coupled or conjugated to a specific binding agent or capture molecule that allows selective removal of the subtraction DNA probes based on the specific binding agent or capture molecule. The subtraction DNA probes can also be attached to or captured on a solid substrate that has one or more properties that allow separation. For example, the subtraction DNA probes can be attached to or captured on magnetic beads, which then can be separated by application of a magnetic field.

### Materials

Disclosed are materials, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a probe is disclosed and discussed and a number of modifications that can be made to a number of molecules including the probe are discussed, each and every combination and permutation of probe and the modifications that are possible are specifically contemplated unless specifically indicated to the contrary. Thus, if a class of molecules A, B, and C are disclosed as well as a class of molecules D, E, and F and an example of a combination molecule, A-D is disclosed, then even if each is not individually recited, each is individually and collectively contemplated. Thus, in this example, each of the combinations A-E, A-F, B-D, B-E, B-F, C-D, C-E, and C—F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this application including, but not limited to, steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

A. Target DNA Probes

Target DNA probes are nucleic acid molecules that are used in the disclosed methods to bind target RNA molecules and facilitate separation of the resulting RNA/DNA hybrids from other compounds and molecules. For this purpose, target DNA probes can have several features. Generally, target DNA probes include target complement sequences, signature sequences, and nucleotide-based bar codes. Target complement sequences are complementary to a sequence in a target RNA molecule. Target complement sequences mediate formation of sequence-specific RNA/DNA hybrids between target DNA probes and target RNA molecules. Generally, signature sequences are sequences designed to be complementary to (or to match) to primer or probe sequences. Signature sequences can be used, for example, to amplify target DNA probes, for primer extension (including primer extension sequencing), and to bind probes (in order to, for example, capture or identify target DNA probes). Particularly useful target DNA probes have a first signature sequence and a second signature sequence that flank the target complement sequence in the target DNA probe. Nucleotide-based bar codes are designed to provide one or more identifying sequence tags to target DNA probes. Target DNA probes can also include detection sequences. Detection sequences can be used for any purpose, but are particularly useful for mediating detection an/or quantitation of target DNA probes. For example, detection sequences can bind primers used for detecting target DNA probes. A detection sequence can be part of one of the signature sequences, between both of the signature sequences, or both.

Although the target complement sequence of a target DNA probe can be used to identify the target DNA probe, use of nucleotide-based bar codes allows separate identification of numerous different target DNA probes that have the same target complement sequence. For example, such target DNA probes can be used to detect and distinguish the same target RNA molecule in numerous different RNA samples by using a unique nucleotide-based bar code in each target DNA probe used in each different sample.

Target DNA probes can have a variety of forms and can be used in various combinations. For example, each of the target DNA probes for a different target RNA molecule can have at least one different nucleotide-based bar code, each of the target DNA probes that corresponds to a different RNA sample can have a different nucleotide-based bar code, each of the target DNA probes that corresponds to a different RNA sample can have at least one different nucleotide-based bar code, each of the target DNA probes for a different target RNA molecule can have a different combination of nucleotide-based bar codes, each of the target DNA probes that corresponds to a different RNA sample can have a different combination of nucleotide-based bar codes, target DNA probes can comprise a single nucleotide-based bar code, target DNA probes can comprise a first nucleotide-based bar code and a second nucleotide-based bar code, target DNA probes can comprise a detection sequence, and target DNA probes can comprise a second detection sequence.

Target DNA probes can be used alone or in sets. Sets of target DNA probes are useful, for example, for detecting and measuring multiple target RNA molecules, RNA molecules in multiple samples, or a combination. For example, a plurality of target DNA probes can be brought into contact with an RNA sample, where each of the plurality of target DNA probes can be for a different target RNA molecule. For example, the different target DNA probes can each have a different nucleotide-based bar code, each designating or corresponding to the sample in which it is used.

As another example, each of the target DNA probes for a different target RNA molecule can have a different nucleotide-based bar code. For example, the different target DNA probes can each have a different nucleotide-based bar code, each designating or corresponding to the target RNA molecule to which the target DNA probe is complementary.

Target DNA probes in a set can have a variety of relationships, which can be related to the intended use of the set of target DNA probes. For example, each of the target DNA probes in a set can be for a different target RNA molecule, a different RNA sample, or both. As another example, each of the target DNA probes for a different target RNA molecule can have a different nucleotide-based bar code. As another example, two or more of the target DNA probes can correspond to different RNA samples, where each of the target DNA probes corresponding to a different RNA sample has a different nucleotide-based bar code. As other examples, each of the target DNA probes for a different target RNA molecule can have at least one different nucleotide bar code, each of the target DNA probes for a different target RNA molecule can have a different combination of nucleotide bar codes, at least one of the target DNA probes can comprise a single nucleotide-based bar code, at least one of the target DNA probes can comprise a first nucleotide-based bar code and a second nucleotide-based bar code, each of the target DNA probes for a different target RNA molecule can have at least one different nucleotide-based bar code, each of the target DNA probes for a different target RNA molecule can have a different combination of nucleotide-based bar codes, two or more of the target DNA probes can correspond to different RNA samples, where each of the target DNA probes corresponding to a different RNA sample has a different combination of nucleotide-based bar codes, and each of the target DNA probes can comprise a detection sequence, where the detection sequence is part of one of the signature sequences, between both of the signature sequences, or both.

Various target DNA probes are referred to herein as being “for” target RNA molecules. By this is meant that a given target DNA probe is intended to hybridize to the indicated target RNA molecule. In the context of the disclosed target DNA probes, this generally means that the target complement sequence of the target DNA probe is complementary to sequence on the target RNA molecule. Given this relationship, target DNA probes that are for target RNA molecules can be said to correspond to the target DNA probes.

Sets of target DNA probes can include any number of different target DNA probes. For example, sets of target DNA probes can have at least 100 different target DNA probes, at least 1000 different target DNA probes, at least 10,000 different target DNA probes, or at least 100,000 different target DNA probes. Unless the context clearly indicates otherwise, reference to multiple target DNA probes refers to multiple different target DNA probes where the different target DNA probes have some difference in structure. Generally, the different target DNA probes will differ in nucleotide sequences from each other. It should also be understood that the disclosed methods generally make use of multiple copies of any given component, such as an individual target DNA probe. Thus, for example, where 1 ng of each of 100 different target DNA probes is used, there will be numerous identical copies present of each of the 100 different target DNA probes.

1. Target Complement Sequences

Target complement sequences are sequences in target DNA probes that are complementary to a sequence in a target RNA molecule. Target complement sequences mediate formation of sequence-specific RNA/DNA hybrids between target DNA probes and target RNA molecules. Target complement sequences can be located anywhere in a target DNA probe. For example, the target complement sequence can be disposed in the target DNA probe between the first signature sequence and the second signature sequence. Disposed in refers to the location of a component relative to other components. In the context of nucleic acid sequences, a component disposed next to or between a second component is in the same sequence or molecule in the indicated position.

Target complement sequences generally have the same function as other nucleic acid probes designed to hybridize in a sequence-specific manner to their complements. The design principles, including melting temperatures and hybridization conditions, know and use for probes in general can be used in designing target complement sequences.

2. Nucleotide-Based Bar Codes

Nucleotide-based bar codes are sequences in target DNA probes that are used to tag, index, and/or identify particular target DNA probes, target DNA probes used in a particular way, or a combination. Nucleotide-based bar codes are designed to provide one or more identifying sequence tags to target DNA probes. Nucleotide-based bar codes allow separate identification of numerous different target DNA probes that have the same target complement sequence. Nucleotide-encoded bar codes also allow different samples to be combined (multiplexed) with the goal of reducing the cost, time, effort, and/or variability of the detection method. For example, such target DNA probes can be used to detect and distinguish the same target RNA molecule in numerous different RNA samples by using a unique nucleotide-based bar code in each target DNA probe used in each different sample. For example, each of the target DNA probes for a different target RNA molecule can have at least one different nucleotide-based bar code, each of the target DNA probes that corresponds to a different RNA sample can have a different nucleotide-based bar code, each of the target DNA probes that corresponds to a different RNA sample can have at least one different nucleotide-based bar code, each of the target DNA probes for a different target RNA molecule can have a different combination of nucleotide-based bar codes, each of the target DNA probes that corresponds to a different RNA sample can have a different combination of nucleotide-based bar codes, target DNA probes can comprise a single nucleotide-based bar code, target DNA probes can comprise a first nucleotide-based bar code and a second nucleotide-based bar code, target DNA probes can comprise a detection sequence, and target DNA probes can comprise a second detection sequence. Nucleotide-encoded bar codes can also be used to encode differences between similar target DNA sequences, so that the identity of the corresponding RNA target can be unambiguously identified with very limited sequencing. For example, RNA splice variants that are junctions between a 5′ exon and different combinations of 3′ exons, will all have the same 5′ sequence. The presence of a relatively short barcode specific for each variant, would allow those targets to be identified with relatively limited sequencing.

Nucleotide-based bar codes can have any length that allows their use to tag, index and/or identify particular target DNA probes, target DNA probes used in a particular way, or a combination. Given this, the length of nucleotide-based bar codes is limited only by the sequences and/or complexity of sequence present when the nucleotide-based bar codes are to be used for identification. Generally, for this purpose, nucleotide-based bar codes will be more than 1, more than 2, more than 3, more than 4, or more than 5 nucleotides long. Different nucleotide-based bar codes used together (whether in the same target DNA probe, assay, method, etc.) can have the same length, different lengths, or some of the same length and some different length. Nucleotide-based bar codes can be for example, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 45, 50, 55, 60, 65, 70, 75, 80, 85, 90, 95 or 100 nucleotides long. Nucleotide-based bar codes can be, for example, at least 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 45, 50, 55, 60, 65, 70, 75, 80, 85, 90, 95 or 100 nucleotides long. Nucleotide-based bar codes can be, for example, less than 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 45, 50, 55, 60, 65, 70, 75, 80, 85, 90, 95 or 100 nucleotides long. Nucleotide-based bar codes can be, for example, any range of length between 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 45, 50, 55, 60, 65, 70, 75, 80, 85, 90, 95 or 100 nucleotides and 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 45, 50, 55, 60, 65, 70, 75, 80, 85, 90, 95 or 100 nucleotides.

The only upper limit on the length of nucleotide-based bar codes is their practicality and operability. Thus, for example, although nucleotide bars greater than 100 nucleotides can be used in the disclosed methods, such use is less than desirable because it would require producing and using target DNA probes of more than 100 nucleotides. Further, lengthy nucleotide-based bar codes would increase the sequence complexity of the target DNA probe pool, which could interfere with the method. For the identification of numerous target DNA probes (or other nucleic acids containing nucleotide-based bar codes), it is more useful to use multiple different nucleotide-based bar codes in a given target DBA probe rather than a longer nucleotide-based bar code.

It useful for the target DNA probes to be uniquely labeled since this label can be used to identify a particular target DNA probe. Sequences in target DNA probes used to provide this labeling are referred to as nucleotide-based bar codes. Nucleotide-based bar codes are unique sequences present in a target DNA probe that uniquely identify that target DNA probe. Target DNA probes can have one or multiple nucleotide-based bar codes, and nucleotide-based bar codes can be in different locations in the target DNA probe. For example, a nucleotide-based bar code can be disposed in the target DNA probe between the first signature sequence and the target complement sequence, a nucleotide-based bar code can be disposed in the target DNA probe between the target complement sequence and the second signature sequence, and a first nucleotide-based bar code can be disposed in the target DNA probe between the first signature sequence and the target complement sequence and a second nucleotide-based bar code is disposed in the target DNA probe between the target complement sequence and the second signature sequence.

In addition, one or more nucleotide-based bar codes can be adjusted to each other in the target DNA probe. For example, the first nucleotide-based bar code can be adjacent to the second nucleotide-based bar code. Adjacent nucleotide-based bar codes can be disposed in the target DNA probe in different locations in the target DNA probe. For example, adjacent nucleotide-based bar codes can be disposed in the target DNA probe between the first signature sequence and the target complement sequence or between the target complement sequence and the second signature sequence.

Multiple nucleotide-based bar codes can be used to detect, identify, and distinguish different target DNA probes. For example, the nucleotide-based bar codes of each of the target DNA probes for a different target RNA molecule can be different from the nucleotide-based bar codes of the other target DNA probes, and the nucleotide-based bar codes of each of the target DNA probes that corresponds to a different RNA sample can be different from the nucleotide-based bar codes of the other target DNA probes. As another example, two or more of the target DNA probes can correspond to different RNA samples and the nucleotide-based bar codes of each of the target DNA probes corresponding to a different RNA sample can be different from the nucleotide-based bar codes of the other target DNA probes.

B. RNA Samples

Samples to be used in the disclosed methods can be from any source identified as containing, or expected to contain, RNA. Useful samples are those suspected or expected to contain one or more target RNA molecules. Samples can be, for example, subjects of a screen to determine which samples contain particular target RNA molecules, a body fluid or extract from a patient or other animal suspected of being infected or suffering from a disease condition, or an environmental sample (for example, soil or water) suspected of harboring a particular organism.

Samples for use in the disclosed methods can also be from any source containing or suspected of containing nucleic acid, where the nucleic acid has been treated to produce at least some RNA from the nucleic acid. The source of nucleic acid can be in purified or non-purified form. Useful types of samples, or sources of samples, that are suitable for use in the disclosed methods are those samples already known or identified as samples suitable for use in other methods of nucleic acid detection and/or quantitation. Many such samples are known. For example, the sample may be from an agricultural or food product, or may be a human or veterinary clinical specimen. In some forms, the sample can a biological fluid such as plasma, serum, blood, urine, sputum or the like. The sample can contain bacteria, yeast, viruses and the cells or tissues of higher organisms such as plants or animals, suspected of harboring an RNA of interest. Methods for the extraction and/or purification of RNA are known and can be used with the disclosed methods.

RNA samples can comprise RNA derived from biological materials. The biological material can comprise cells, tissues, biological fluids, extracellular solutions, extracellular matrices, synthetic biological materials, or a combination. In the case of biological fluids, extracellular solutions, extracellular matrices, and the like, RNA can have been release into the biological fluids, extracellular solutions, extracellular matrices and the like. In addition to RNA, the sample can contain other components such as DNA, proteins, metabolites, etc. For example, RNA samples can be derived from body fluids, cells, tissues, and the like from any source or any organism. The disclosed RNA sample can comprise DNA, RNA, or both. In one embodiment of the disclosed methods of detecting target RNA molecules, at least 100, 1000, 10000, or 100000 different target DNA probes can be brought into contact with the RNA sample.

C. Target RNA Molecules

Target RNA molecules are any RNA molecule to be detected or measured. That is, any RNA molecule of interest can be a target RNA molecule. Further, any nucleic acid sequence of interest that can be converted to RNA can be the source of a target RNA molecule. Useful target RNA molecules can include, for example, microRNA molecules, mRNA, noncoding RNA, variant RNA sequences, variant RNA sequences resulting from the presence of DNA polymorphisms, variant RNA sequences resulting from the splice variations, and RNA sequences resulting from RNA editing.

As used herein, the term “microRNA” (or miRNA) refers to any type of interfering RNA, including but not limited to, endogenous microRNA and artificial microRNA. Endogenous microRNA are small RNAs naturally present in the genome which are capable of modulating the productive utilization of mRNA. The term “artificial” or “synthetic” microRNA includes any type of RNA sequence, other than endogenous microRNA, which is capable of modulating the productive utilization of mRNA.

Noncoding RNA molecules are RNA molecules that do not encode a protein or peptide. Although many RNA molecules include sequences that match codons in the genetic code, in noncoding RNA these sequences do not support translation into amino acid sequence. Thus, as used herein, noncoding RNA refers to the lack of a functional capability of the RNA to be translated or to the lack of a functional capability of the source of an RNA molecule. For example, an RNA molecule containing sequence derived from a coding sequence in the source molecule can be considered to be coding RNA even though it could not be effectively translated in its current form. As an example, exon sequences are coding RNA and intron sequences are noncoding RNA.

Noncoding RNA genes produce functional RNA molecules with important roles in regulation of gene expression, developmental timing, viral surveillance, and immunity. Not only the classic transfer RNAs (tRNAs) and ribosomal RNAs (rRNAs), but also small nuclear RNAs (snRNAs), small nucleolar RNAs (snoRNAs), small interfering RNAs (siRNAs), tiny non-coding RNAs (tncRNAs), repeat-associated small interfering RNAs (rasiRNAs) and microRNAs (miRNAs) are now believed to act in diverse cellular processes such as chromosome maintenance, gene imprinting, pre-mRNA splicing, guiding RNA modifications, transcriptional regulation, and the control of mRNA translation (Eddy, Nat. Rev. Genet. (2001) 2:919-929; Kawasaki and Taira, Nature (2003) 423:838-842; Aravin, et al., Dev. Cell (2003) 5:337-350). RNA-mediated processes are now also believed to direct heterochromatin formation, genome rearrangements, and DNA elimination (Cerutti, Trends Genet. (2003) 19:39-46; Couzin, Science (2002) 298:2296-2297).

The double-stranded ribonucleic acid molecule of the cell-permeable complex may be any one of a number of noncoding RNAs (i.e., RNA which is not mRNA, tRNA or rRNA), including, preferably, a small interfering RNA, but may also comprise a small temporal RNA, small nuclear RNA, small nucleolar RNA, short hairpin RNA or a microRNA comprising a double-stranded structure and/or a stem loop configuration comprising an RNA duplex with or without one or more single strand overhang.

Target RNA molecules can include or embody variant sequences. Useful variant sequences can be any form of a given sequence having one or more changes to the sequence. For example, variants can include nucleotides substitutions, deletions, insertions. DNA polymorphisms can also be the source of variant sequences. DNA polymorphism refers to the condition in which two or more different nucleotide sequences can exist at a particular site in DNA and includes any nucleotide variation, such as single or multiple nucleotide substitutions, deletions or insertions. These nucleotide variations can be mutant or polymorphic allele variations.

Other variants include RNA splicing or RNA editing variants. RNA splicing variants can often have sequences similar or identical to the normal or alternative sequence but with a unique junction of those sequences.

Variant sequences and derivatives can also be defined in terms of similarity, identity, and/or homology to specific known sequences. This identity of particular sequences disclosed herein is also discussed elsewhere herein. In general, variants of DNA, RNA and proteins herein disclosed typically have at least, about 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 percent homology to the stated sequence or the native sequence. Those of skill in the art readily understand how to determine the homology of two proteins or nucleic acids, such as RNA molecules. For example, the homology can be calculated after aligning the two sequences so that the homology is at its highest level. As used herein, homology of sequences can be considered sequence identity.

Another way of calculating homology can be performed by published algorithms. Optimal alignment of sequences for comparison may be conducted by the local homology algorithm of Smith and Waterman, Adv. Appl. Math. (1981) 2:482, by the homology alignment algorithm of Needleman and Wunsch, J. Mol. Biol. (1970) 48:443, by the search for similarity method of Pearson and Lipman, Proc. Natl. Acad. Sci. U.S.A. (1988) 85:2444, by computerized implementations of these algorithms (GAP, BESTFIT, FASTA, and TFASTA in the Wisconsin Genetics Software Package, Genetics Computer Group, 575 Science Dr., Madison, Wis.), or by inspection.

The same types of homology can be obtained for nucleic acids by for example the algorithms disclosed in Zuker, M., Science (1989) 244:48-52, Jaeger, et al. Proc. Natl. Acad. Sci. USA (1989) 86:7706-7710, Jaeger, et al. Methods Enzymol. (1989) 183:281-306, which are herein incorporated by reference for at least material related to nucleic acid alignment. It is understood that any of the methods typically can be used and that in certain instances the results of these various methods may differ, but the skilled artisan understands if identity is found with at least one of these methods, the sequences would be said to have the stated identity, and be disclosed herein.

For example, as used herein, a sequence recited as having a particular percent homology to another sequence refers to sequences that have the recited homology as calculated by any one or more of the calculation methods described above. For example, a first sequence has 80 percent homology, as defined herein, to a second sequence if the first sequence is calculated to have 80 percent homology to the second sequence using the Zuker calculation method even if the first sequence does not have 80 percent homology to the second sequence as calculated by any of the other calculation methods. As another example, a first sequence has 80 percent homology, as defined herein, to a second sequence if the first sequence is calculated to have 80 percent homology to the second sequence using both the Zuker calculation method and the Pearson and Lipman calculation method even if the first sequence does not have 80 percent homology to the second sequence as calculated by the Smith and Waterman calculation method, the Needleman and Wunsch calculation method, the Jaeger calculation methods, or any of the other calculation methods. As yet another example, a first sequence has 80 percent homology, as defined herein, to a second sequence if the first sequence is calculated to have 80 percent homology to the second sequence using each of calculation methods (although, in practice, the different calculation methods will often result in different calculated homology percentages).

D. Subtraction DNA Probes

Subtraction DNA probes are nucleic acid molecules that are used in the disclosed methods to bind RNA molecules to be removed from RNA samples and facilitate separation of the resulting RNA/DNA hybrids from other compounds and molecules. In the disclosed methods, this process is generally used to eliminate unwanted RNA molecules from RNA samples and so can be referred to as sequence subtraction. Although subtraction DNA probes can have several features, generally, subtraction DNA probes need only include target complement sequences. Target complement sequences are complementary to a sequence in an RNA molecule to be removed. Target complement sequences mediate formation of sequence-specific RNA/DNA hybrids between subtraction DNA probes and RNA molecules to be removed.

E. Specific Binding Agents

A specific binding agent is any compound that can bind or interact specifically with a particular compound or composition or a particular class or type of compound or composition. For example, a specific binding agent can be an antibody that specifically binds to a molecule or analyte, such as RNA/DNA hybrids. As another example, a specific binding agent can be a compound, such as a ligand or hapten, that specifically binds to or interacts with another compound, such as ligand-binding molecule or an antibody. As another example, a specific binding agent can be a compound or composition that specifically binds to RNA/DNA hybrids. The interaction between the specific binding agent and the bound component can be a specific interaction, such as between a hapten and an antibody or a ligand and a ligand-binding molecule.

Useful specific binding agents, described in the context of nucleic acid probes, are described by Syvnen, et al., Nucleic Acids Res. (1986) 14:5037. Useful specific binding agent include biotin, avidin, streptavidin, NeutrAvidin®, or an antibody. In the disclosed methods, specific binding agents can, for example, bind to RNA/DNA hybrids to aid in separating target DNA probes and/or subtraction DNA probes hybridized to RNA molecules from RNA samples. Specific binding agents can also be used to bind to capture molecules, which allow the specific binding agent to be captured by, adhered to, or coupled to a capture substrate. This can allow any molecule bound to or conjugate with specific binding agent to be captured by, adhered to, or coupled to a capture substrate. Specific binding agents can also bind to or be conjugated with a solid substrate. For example, a specific binding agent specific for RNA/DNA hybrids can be conjugated to a solid support, which allows the capture of RNA/DNA hybrids on the solid support. As another example, a specific binding specific for RNA/DNA hybrids can bind to a solid substrate (directly or via a capture molecule, for example), which allows the capture of RNA/DNA hybrids on the solid support. Thus, in some forms of specific binding agents, one portion of the specific binding agent can bind to an analyte, such as the RNA/DNA hybrids produced in the disclosed methods, and another portion can bind to a solid substrate. Such capture allows simplified washing and handling of the RNA/DNA hybrids, and allows automation of all or part of the method.

Capturing RNA/DNA hybrids on a capture substrate can be accomplished in several ways. In some forms, capture molecules can be adhered or coupled to the capture substrate. Capture molecules are a form of specific binding agent that mediate adherence of an analyte to a capture substrate by binding to, or interacting with, another specific binding agent that binds to the analyte. For example, capture molecules immobilized on a capture substrate allow capture of RNA/DNA hybrids on the capture substrate via specific binding agents that bind to both RNA/DNA hybrids and to the capture molecule. Such capture provides a convenient means of separating analytes, such as RNA/DNA hybrids, from other molecules in an RNA sample, and of washing away reaction components that might interfere with subsequent steps. For example, capture molecules can comprise biotin, avidin, streptavidin, NeutrAvidin®, or anti-antibody antibody.

The specific binding agent can be an antibody specific for RNA/DNA hybrids. Such antibodies are known. For example, high affinity, specific antibodies for RNA/DNA hybrids include mouse monoclonal S9.6. Such antibodies are largely sequence non-specific, which makes them useful for binding RNA/DNA hybrids in general. Useful RNA/DNA hybrid-specific monoclonal antibodies are also described in U.S. Pat. Nos. 4,732,847 and 4,833,084, which are incorporated herein by reference in their entirety, and specifically for their description of RNA/DNA hybrid-specific antibodies. Polyclonal antibodies, such as goat 4 A-E purified IgG, goat 4H antiserum and sheep 4B antiserum, can also be used to bind RNA/DNA hybrids (Kitagawa, et al., Mol Immunol (1982); Stollar, et al., Anal Biochem (1987)).

The disclosed specific binding agents can also include one or more capture molecules. For example, an antibody can comprise a capture molecule. The capture molecule can facilitate conjugation of the specific binding agent to a solid substrate, for example.

A specific binding agent that interacts specifically with a particular molecule is said to be specific for that molecule. For example, where the specific binding agent is an antibody that binds to a particular antigen, the specific binding agent is said to be specific for that antigen. Other examples include specific binding agents being specific for RNA/DNA hybrids and antibodies being specific for RNA/DNA hybrids. As these examples show, specific binding or interaction can be specific for a class or group of compounds or compositions and is not limited to specific binding or interaction of one particular compound or composition (although many specific binding agents are specific for a particular compound or composition). Specificity of binding need not, and often will not, be absolute. Rather, specific binding or specific interaction refers to a preference for the specific binding agent for its target compound. Such preference can be categorized as binding with, for example, at least 2, 3, 4, 5, 6, 7, 8, 9, 10, 11, 12, 13, 14, 15, 16, 17, 18, 19, 20, 30, 40, 50, 60, 70, 80, 90, 100, 200, 300, 400, 500, 600, 700, 800, 900, 10³, 10⁴, 10⁵, 10⁶ or 10⁷ greater affinity for the target compound as for other compounds that are present.

3. Antibodies

Antibodies can be used for a variety of purposes including as specific binding agents and in the disclosed methods. Antibodies can be either monoclonal or polyclonal antibodies. Mixtures of monoclonal and polyclonal antibodies can also be used. The disclosed methods can make use of antibodies produced with specific binding properties. For example, antibodies can be used to bind RNA/DNA hybrids. For instance, monoclonal or polyclonal antibodies that specifically bind to very short (less than 20 base pairs) RNA/DNA hybrids can be produced and used in the disclosed methods to bind very short RNA/DNA hybrids produced in the disclosed methods. Such binding can be used in a variety of ways in the disclosed methods, such as for separating RNA/DNA hybrids from samples or from other compounds and compositions, for detecting RNA/DAN hybrids, and for removing unwanted RNA molecules from the sample before detecting target RNA molecules. In addition, antibodies can be produced that are either more or less sensitive to mismatches within the RNA/DNA hybrid. Antibodies that are more sensitive to mismatches within the RNA/DNA hybrid can be used, for example, to detect particular forms of RNA molecules where close variants are also present. Antibodies which are less sensitive to mismatches with the RNA/DNA hybrid can be used, for example, to detect a class of related RNA molecules.

Disclosed are antibodies that bind RNA/DNA hybrids independent of sequence but with high affinity. Such antibody:RNA/DNA hybrid complexes allow separation of the RNA/DNA hybrid from a RNA sample.

The term “antibodies” is used herein in a broad sense and includes both polyclonal and monoclonal antibodies. In addition to intact immunoglobulin molecules, also included in the term “antibodies” are fragments or polymers of those immunoglobulin molecules, and human or humanized versions of immunoglobulin molecules or fragments thereof, as described herein. Antibodies can be tested for their desired activity using the in vitro assays described herein, or by analogous methods.

Also included within the meaning of “antibody or fragments thereof” are conjugates of antibody fragments and antigen binding proteins (single chain antibodies) as described, for example, in U.S. Pat. No. 4,704,692, the contents of which are hereby incorporated by reference.

F. Solid Substrate

Solid substrates for use in the disclosed methods can include any solid material to which specific binding agents and capture molecules can be coupled, directly or indirectly. This includes materials such as acrylamide, cellulose, nitrocellulose, glass, polystyrene, polyethylene vinyl acetate, polypropylene, polymethacrylate, polyethylene, polyethylene oxide, polysilicates, polycarbonates, Teflon®, fluorocarbons, nylon, silicon rubber, polyanhydrides, polyglycolic acid, polylactic acid, polyorthoesters, polypropylfumerate, collagen, glycosaminoglycans, and polyamino acids. Solid substrates can have any useful form including thin films or membranes, beads, bottles, columns, dishes, fibers, tubes, slides, woven fibers, shaped polymers, particles and microparticles. Preferred forms of the solid substrate are tubes, slides, or beads.

Specific binding agents and capture molecules can be conjugated to a solid substrate. In this way, target DNA probes hybridized to target RNA molecules can be separated from the RNA sample by separating the solid substrate from the RNA sample. Capture substrates are solid substrates to which capture molecules have been conjugated.

Specific binding agents and capture molecules can be directly or indirectly conjugated to the solid substrate. Direct conjugation to the solid substrate can be achieved via reactive groups. In some embodiments, the material comprising the solid support has reactive groups such as carboxy, amino, hydroxy, etc., which are used for covalent or non-covalent attachment of the specific binding agents. Suitable polymers may include, but are not limited to, polystyrene, polyethylene glycol tetraphthalate, polyvinyl acetate, polyvinyl chloride, polyvinyl pyrrolidone, polyacrylonitrile, polymethyl methacrylate, polytetrafluoroethylene, butyl rubber, styrenebutadiene rubber, natural rubber, polyethylene, polypropylene, (poly)tetrafluoroethylene, (poly)vinylidenefluoride, polycarbonate and polymethylpentene. Other polymers include those outlined in U.S. Pat. No. 5,427,779 to Elsner, H., et al., hereby expressly incorporated by reference.

Indirect conjugation to the solid substrate can be achieved in a variety of ways, Generally, indirect conjugation is conjugation via or through one or more intervening components. For example, specific binding agents and capture molecules can be conjugated with biotin and the solid support can be conjugated with avidin or streptavidin, or vice versa. Biotin binds selectively to streptavidin and thus, the specific binding agent can be conjugated with the solid support in this indirect manner. Alternatively, to achieve indirect conjugation of the specific binding agent with the solid support, the specific binding agent is conjugated with a small hapten (e.g., digoxin) and one of the solid support is conjugated with an anti-hapten polypeptide variant (e.g., anti-digoxin antibody). Thus, indirect conjugation of the specific binding agent with the solid support can be achieved (Hermanson, G. (1996) in Bioconjugate Techniques, Academic Press, San Diego).

G. Nucleic Acids

So long as their relevant function is maintained, target “DNA” probes, subtraction “DNA” probes and any other oligonucleotides and nucleic acids can be made up of or include modified nucleotides (nucleotide analogs). Many modified nucleotides are known and can be used in oligonucleotides and nucleic acids. A nucleotide analog is a nucleotide which contains some type of modification to either the base, sugar, or phosphate moieties. Modifications to the base moiety would include natural and synthetic modifications of A, C, G, and T/U as well as different purine or pyrimidine bases, such as uracil-5-yl, hypoxanthin-9-yl (I), and 2-aminoadenin-9-yl. A modified base includes, for example, 5-methylcytosine (5-me-C), 5-hydroxymethyl cytosine, xanthine, hypoxanthine, 2-aminoadenine, 6-methyl and other alkyl derivatives of adenine and many others.

The “DNA” probes may also comprise LNA™ monomers—a class of nucleic acid analogues in which the ribose ring is “locked” into the ideal conformation for base stacking and backbone pre-organization and can be used just like a regular nucleotide. The nucleic acid contains a methylene bridge connecting the 2′-O and the 4′-C. The “locked” structure increases the stability of oligonucleotides by means of increasing the melting temperature (Kaur, et al., Biochemistry (2006) 45:7347-7355). LNA™ can be used for a variety of molecular biology techniques. Locked nucleic acids can be used for but are not limited to microarrays, FISH probes, real-time PCR probes, small RNA research, SNP genotyping, mRNA antisense oligonucleotides, allele-specific PCR, RNAi, DNAzymes, fluorescence polarization probes, gene repair/exon skipping, splice variant detection and comparative genome hybridization.

The DNA probes may also comprise nucleotide analogs. These can also include modifications of the sugar moiety. Modifications to the sugar moiety would include natural modifications of the ribose and deoxyribose as well as synthetic modifications.

Such nucleotide analogs can also be modified at the phosphate moiety. Modified phosphate moieties include but are not limited to those that can be modified so that the linkage between two nucleotides contains a phosphorothioate, chiral phosphorothioate, phosphorodithioate, phosphotriester, aminoalkylphosphotriester, methyl and other alkyl phosphonates including 3′-alkylene phosphonate and chiral phosphonates, phosphinates, phosphoramidates including 3′-amino phosphoramidate and aminoalkylphosphoramidates, thionophosphoramidates, thionoalkylphosphonates, thionoalkylphosphotriesters, and boranophosphates. It is understood that these phosphate or modified phosphate linkages between two nucleotides can be through a 3′-5′ linkage or a 2′-5′ linkage, and the linkage can contain inverted polarity such as 3′-5′ to 5′-3′ or 2′-5′ to 5′-2′. Various salts, mixed salts and free acid forms are also included. Numerous United States patents describe how to make and use nucleotides containing modified phosphates.

It is understood that nucleotide analogs need only contain a single modification, but can also contain multiple modifications within one of the moieties or between different moieties.

The DNA probes can also comprise nucleotide substitutes—molecules having similar functional properties to nucleotides, but which do not contain a phosphate moiety, such as peptide nucleic acid (PNA). Nucleotide substitutes are molecules that will recognize and hybridize to (base pair to) complementary nucleic acids in a Watson-Crick or Hoogsteen manner, but which are linked together through a moiety other than a phosphate moiety. Nucleotide substitutes are able to conform to a double helix type structure when interacting with the appropriate target nucleic acid.

Nucleotide substitutes can also include nucleotides or nucleotide analogs that have had the phosphate moiety and/or sugar moieties replaced. Nucleotide substitutes do not contain a standard phosphorus atom. Substitutes for the phosphate can be for example, short chain alkyl or cycloalkyl internucleoside linkages, mixed heteroatom and alkyl or cycloalkyl internucleoside linkages, or one or more short chain heteroatomic or heterocyclic internucleoside linkages. These include those having morpholino linkages (formed in part from the sugar portion of a nucleoside); siloxane backbones; sulfide, sulfoxide and sulfone backbones; formacetyl and thioformacetyl backbones; methylene formacetyl and thioformacetyl backbones; alkene containing backbones; sulfamate backbones; methyleneimino and methylenehydrazino backbones; sulfonate and sulfonamide backbones; amide backbones; and others having mixed N, O, S and CH₂ component parts. Numerous United States patents disclose how to make and use these types of phosphate replacements.

Nucleotide substitutes may have both the sugar and the phosphate moieties of the nucleotide replaced, by for example an amide type linkage (aminoethylglycine) (PNA). U.S. Pat. Nos. 5,539,082; 5,714,331; and 5,719,262 teach how to make and use PNA molecules, each of which is herein incorporated by reference. (See also Nielsen, et al., Science (1991) 254:1497-1500).

It is also possible to link other types of molecules (conjugates) to nucleotides or nucleotide analogs to enhance for example, cellular uptake. Conjugates can be chemically linked to the nucleotide or nucleotide analogs. Such conjugates include but are not limited to lipid moieties such as a cholesterol moiety. (Letsinger, et al., Proc. Natl. Acad. Sci. USA (1989) 86:6553-6556). There are many varieties of these types of molecules available in the art and available herein.

4. Primers and Probes

Disclosed are compositions including primers and probes, which are capable of interacting with the disclosed nucleic acids such as target RNA molecules and target DNA probes. In certain embodiments the primers are used to support DNA amplification reactions. Typically the primers will be capable of being extended in a sequence specific manner. Extension of a primer in a sequence specific manner includes any methods wherein the sequence and/or composition of the nucleic acid molecule to which the primer is hybridized or otherwise associated directs or influences the composition or sequence of the product produced by the extension of the primer. Extension of the primer in a sequence specific manner therefore includes, but is not limited to, PCR, DNA sequencing, DNA extension, DNA polymerization, RNA transcription, or reverse transcription. Techniques and conditions that amplify the primer in a sequence specific manner are preferred. In certain embodiments the primers are used for the DNA amplification reactions, such as PCR or direct sequencing. It is understood that in certain embodiments the primers can also be extended using non-enzymatic techniques, where for example, the nucleotides or oligonucleotides used to extend the primer are modified such that they will chemically react to extend the primer in a sequence specific manner. Typically the disclosed primers hybridize with the disclosed nucleic acids or region of the nucleic acids or they hybridize with the complement of the nucleic acids or complement of a region of the nucleic acids.

The size of the primers or probes for interaction with the nucleic acids in certain embodiments can be any size that supports the desired enzymatic manipulation of the primer, such as DNA amplification or the simple hybridization of the probe or primer. A typical primer or probe would be at least 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 125, 150, 175, 200, 225, 250, 275, 300, 325, 350, 375, 400, 425, 450, 475, 500, 550, 600, 650, 700, 750, 800, 850, 900, 950, 1000, 1250, 1500, 1750, 2000, 2250, 2500, 2750, 3000, 3500, or 4000 nucleotides long.

The primers for the disclosed target DNA probes typically can be used to produce an amplified DNA product that contains a region of the target DNA probe or the complete target DNA probe. For example, the primer can correspond to a signature sequence, a detection sequence, or both. As used herein, a primer corresponds to a nucleic acid molecule or sequence if it contains a sequence that is complementary to, or complementary to a complement of, a sequence in the nucleic acid molecule or sequence such that the primer can function as a primer of the sequence (or its complement) in the nucleic acid molecule or sequence under the conditions used. In general, typically the size of the product can be such that the size can be accurately determined to within 3, or 2 or 1 nucleotides.

In certain embodiments this product is at least 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 125, 150, 175, 200, 225, 250, 275, 300, 325, 350, 375, 400, 425, 450, 475, 500, 550, 600, 650, 700, 750, 800, 850, 900, 950, 1000, 1250, 1500, 1750, 2000, 2250, 2500, 2750, 3000, 3500, or 4000 nucleotides long.

H. Hybridization

The term hybridization typically means a sequence driven interaction between at least two nucleic acid molecules, such as a primer or a probe and a gene. Sequence driven interaction means an interaction that occurs between two nucleotides or nucleotide analogs or nucleotide derivatives in a nucleotide specific manner. For example, G interacting with C or A interacting with T are sequence driven interactions. Typically sequence driven interactions occur on the Watson-Crick face or Hoogsteen face of the nucleotide. The hybridization of two nucleic acids is affected by a number of conditions and parameters known to those of skill in the art. For example, the salt concentrations, pH, and temperature of the reaction all affect whether two nucleic acid molecules will hybridize. Nucleic acid molecules that hybridize can be said to be hybridized and can be referred to as a hybrid. For example, an RNA/DNA hybrid results from hybridization of an RNA molecule and a DNA molecule having complementary sequence.

Parameters for selective hybridization between two nucleic acid molecules are well known to those of skill in the art. For example, in some embodiments selective hybridization conditions can be defined as stringent hybridization conditions. For example, stringency of hybridization is controlled by both temperature and salt concentration of either or both of the hybridization and washing steps. For example, the conditions of hybridization to achieve selective hybridization may involve hybridization in high ionic strength solution (6×SSC or 6×SSPE) at a temperature that is about 12-25° C. below the Tm (the melting temperature at which half of the molecules dissociate from their hybridization partners) followed by washing at a combination of temperature and salt concentration chosen so that the washing temperature is about 5° C. to 20° C. below the Tm. The temperature and salt conditions are readily determined empirically in preliminary experiments in which samples of reference DNA immobilized on filters are hybridized to a labeled nucleic acid of interest and then washed under conditions of different stringencies. Hybridization temperatures are typically higher for DNA-RNA and RNA-RNA hybridizations. The conditions can be used as described above to achieve stringency, or as is known in the art. (Sambrook, et al., Molecular Cloning: A Laboratory Manual, 2nd Ed., Cold Spring Harbor Laboratory, Cold Spring Harbor, N.Y., 1989; Kunkel, et al., Methods Enzymol. (1987) 154:367, which is herein incorporated by reference for material at least related to hybridization of nucleic acids). A preferable stringent hybridization condition for a DNA:DNA hybridization can be at about 68° C. (in aqueous solution) in 6×SSC or 6×SSPE followed by washing at 68° C. Stringency of hybridization and washing, if desired, can be reduced accordingly as the degree of complementarity desired is decreased, and further, depending upon the G-C or A-T richness of any area wherein variability is searched for. Likewise, stringency of hybridization and washing, if desired, can be increased accordingly as homology desired is increased, and further, depending upon the G-C or A-T richness of any area wherein high homology is desired, all as known in the art.

Another way to define selective hybridization is by looking at the amount (percentage) of one of the nucleic acids bound to the other nucleic acid. For example, in some embodiments selective hybridization conditions would be when at least about, 60, 65, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 percent of the limiting nucleic acid is bound to the non-limiting nucleic acid. Typically, the non-limiting primer is in for example, 10 or 100 or 1000 fold excess. This type of assay can be performed at under conditions where both the limiting and non-limiting primer are for example, 10 fold or 100 fold or 1000 fold below their k_{d}, or where only one of the nucleic acid molecules is 10 fold or 100 fold or 1000 fold or where one or both nucleic acid molecules are above their k_{d}.

Another way to define selective hybridization is by looking at the percentage of primer that gets enzymatically manipulated under conditions where hybridization is required to promote the desired enzymatic manipulation. For example, in some embodiments selective hybridization conditions would be when at least about, 60, 65, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 percent of the primer is enzymatically manipulated under conditions which promote the enzymatic manipulation, for example if the enzymatic manipulation is DNA extension, then selective hybridization conditions would be when at least about 60, 65, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 percent of the primer molecules are extended. Preferred conditions also include those suggested by the manufacturer or indicated in the art as being appropriate for the enzyme performing the manipulation.

Just as with homology, it is understood that there are a variety of methods herein disclosed for determining the level of hybridization between two nucleic acid molecules. It is understood that these methods and conditions may provide different percentages of hybridization between two nucleic acid molecules, but unless otherwise indicated meeting the parameters of any of the methods would be sufficient. For example if 80% hybridization was required and as long as hybridization occurs within the required parameters in any one of these methods it is considered disclosed herein.

It is understood that those of skill in the art understand that if a composition or method meets any one of these criteria for determining hybridization either collectively or singly it is a composition or method that is disclosed herein.

I. Kits

The materials described above as well as other materials can be packaged together in any suitable combination as a kit useful for performing, or aiding in the performance of, the disclosed method. It is useful if the kit components in a given kit are designed and adapted for use together in the disclosed method. For example disclosed are kits for measuring small RNA species in a sample, such as a biological sample containing hundreds or thousands of small RNAs, the kit comprising the disclosed materials or a combination thereof. The kits can contain, for example, target DNA probes, specific binding agents, solid supports, capture molecules, capture supports, or a combination.

J. Mixtures

Disclosed are mixtures formed by performing or preparing to perform the disclosed method. For example, disclosed are mixtures comprising an RNA:DNA probe hybrid.

Whenever the method involves mixing or bringing into contact compositions or components or reagents, performing the method creates a number of different mixtures. For example, if the method includes 3 mixing steps, after each one of these steps a unique mixture is formed if the steps are performed separately. In addition, a mixture is formed at the completion of all of the steps regardless of how the steps were performed. The present disclosure contemplates these mixtures, obtained by the performance of the disclosed methods as well as mixtures containing any disclosed reagent, composition, or component, for example, disclosed herein.

K. Systems

Disclosed are systems useful for performing, or aiding in the performance of, the disclosed method. Systems generally comprise combinations of articles of manufacture such as structures, machines, devices, and the like, and compositions, compounds, materials, and the like. Such combinations that are disclosed or that are apparent from the disclosure are contemplated. For example, disclosed and contemplated are systems comprising target DNA probes and NextGen sequencing apparatus.

L. Data Structures and Computer Control

Disclosed are data structures used in, generated by, or generated from, the disclosed method. Data structures generally are any form of data, information, and/or objects collected, organized, stored, and/or embodied in a composition or medium. A profile of target RNA molecules stored in electronic form, such as in RAM or on a storage disk, is a type of data structure.

The disclosed method, or any part thereof or preparation therefor, can be controlled, managed, or otherwise assisted by computer control. Such computer control can be accomplished by a computer controlled process or method, can use and/or generate data structures, and can use a computer program. Such computer control, computer controlled processes, data structures, and computer programs are contemplated and should be understood to be disclosed herein.

The disclosed methods and compositions are applicable to numerous areas including, but not limited to, nucleic acid detection and measurement. Other uses include nucleic acid profiling and analysis, including, for example whole transcriptome analysis. Other uses are disclosed, apparent from the disclosure, and/or will be understood by those in the art.

### EXAMPLES

The disclosed experiment describes a test of the S9.6 antibody RNA detection method coupled to Solexa™ based sequencing. The experiment confirmed that the oligo library design is compatible with the Solexa™ (Illumina®) platform, i.e., that the oligos (without any prior amplification) will generate clusters and produce high quality DNA sequence information, that the S9.6 antibody is able to immunoprecipitate (IP) RNA/DNA hybrids when coupled to magnetic beads, and provided an initial estimate of the levels of background contributed by the DNA oligo probes when annealed to a DNA template or alone.

M. Description and Results

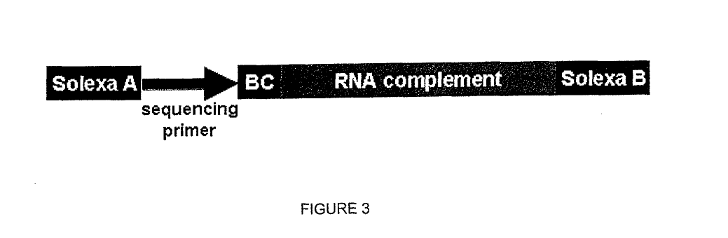

Capture oligonucleotides (FIG. 3) containing sequences compatible with the Solexa™/Illumina® platform, barcodes for sample tracking, and regions complementary to yeast mRNA transcripts or sequences not present in the yeast genome were used. These probes were annealed (by heating and slow cooling in water) either to complementary synthetic RNA oligonucleotides, complementary DNA oligonucleotides, or no oligonucleotides (single stranded probes). These nucleic acid species were spiked into the immunoprecipitation reaction at defined concentrations (Table 1). The S9.6 antibody was coupled to protein G magnetic Dynabeads® (Invitrogen) and used to immunoprecipitate RNA/DNA hybrids out of this mixture. Following the immunoprecipitation reaction, washes, and elution (heating to 95° C. for 5 minutes), a 10 fold dilution series of single-stranded capture oligos was spiked into the eluted sample at defined concentrations (Table 1).

This sample (without further amplification) was denatured and processed through the Solexa™ cluster generation and sequencing pipeline. The results are shown in Table 1. The sequencing run generated approximately 6 million total clusters, of which approximately 5 million perfectly matched one of the expected oligonucleotides across all 17 base pairs sequenced. The number of counts detected for the standard curve oligos (PHO88_BC2, GAL7_{—}1_BC2, GAL7_{—}2_BC2, GAL7_{—}3_BC2) correspond well to a 10 fold dilution series.

This result demonstrates that (1) the capture oligos are capable of generating clusters and being sequenced by the Solexa™ machine without prior amplification, and (2) the results from the Solexa™ run are reasonably quantitative.

TABLE 1
Oligos detected by Solexa ™ sequencing.

| | | | relative | | Re- |
|---|---|---|---|---|---|
| Sequence | Type | Pmoles | [ ] | Counts | covery* |
| YNS1_BC1 | RNA:DNA | 0.01 | 5X | 21,737 | 3.12% |
| YNS2_BC1 | RNA:DNA | 0.002 | 1X | 12,765 | 9.16% |
| PHO88_BC1 | DNA:DNA | 0.1 | 50X | 1,121 | 0.02% |
| GAL7_1_BC1 | DNA:DNA | 0.1 | 50X | 1,588 | 0.03% |
| GAL7_2_BC1 | ssDNA | 0.1 | 50X | 197 | 0.004% |
| GAL7_3_BC1 | ssDNA | 0.1 | 50X | 144 | 0.003% |
| PHO88_BC2 | std. curve | 0.1 | 50X | 4,557,323 | |
| GAL7_1_BC2 | std. curve | 0.01 | 5X | 696,498 | |
| GAL7_2_BC2 | std. curve | 0.001 | 0.5X | 69,762 | |
| GAL7_3_BC2 | std. curve | 0.0001 | 0.05X | 6,463 | |

| | |
|---|---|
| Total matches | 5,367,598 |
| Total clusters | 6,221,125 |

*Recovery = counts recovered as a percentage of those expected based on the standard curve.

To test the ability to quantitatively IP RNA/DNA hybrids, synthetic RNA molecules (YNS1 and YNS2) annealed to their corresponding capture oligos were added at two different concentrations (YNS1 in 5-fold excess of YNS2). Under the IP conditions used in this experiment, between 3-9% of the expected RNA/DNA hybrid was recovered (Table 1). While the recovery of these oligos relative to each other was not different by 5 fold, the oligo added in the higher concentration did generate a larger number of counts.

To test the specificity of the IP under these conditions, capture oligos annealed to DNA oligos (PHO88_BC1 and GAL7_{—}1_BC1) or left single stranded (GAL7_{—}2_BC1 and GAL7_{—}3_BC1), were added in 10-fold molar excess to the highest concentration RNA/DNA hybrid (YNS1). Any detectable level of nonspecific, background in this experiment can be used for optimization experiments. The DNA/DNA hybrid and single stranded oligo were detected at levels ˜100-fold and ˜1000-fold below the RNA/DNA hybrid levels, respectively. It is important to note that in the experimental design, very little double stranded DNA is expected in the hybridization reaction. Different beads and/or wash conditions can be used to lower background levels.

It must be noted that as used herein and in the appended claims, the singular forms “a”, “an”, and “the” include plural reference unless the context clearly dictates otherwise. Thus, for example, reference to “a target DNA probe” includes a plurality of such probes, reference to “the target DNA probe” is a reference to one or more probes and equivalents thereof known to those skilled in the art, and so forth.

1. A method of detecting target RNA molecules, the method comprising (a) bringing into contact an RNA sample and an excess of a DNA probe for each target RNA molecule to be detected, wherein said DNA probe comprises a first signature sequence, a target complement sequence, a second signature sequence, and a nucleotide-based bar code, wherein the target complement sequence is complementary to sequence in a target RNA molecule,
(b) separating said DNA probes hybridized to target RNA molecules from the sample, and
(c) detecting one or more of the separated target DNA probes, wherein the detected target DNA probes are indicative of the presence of the corresponding target RNA molecules.

2. The method of claim 1 further comprising, prior to step (c), amplifying the separated DNA probes using primers corresponding to the first and second signature sequences, wherein the amplified DNA probes are detected in step (c).

3. The method of claim 1, wherein the nucleotide-based bar code is disposed in the DNA probe between the first signature sequence and the second signature sequence.

4. The method of claim 1, wherein a plurality of DNA probes are brought into contact with the RNA sample, wherein each of the plurality of DNA probes is for a different target RNA molecule.

5. The method of claim 1, wherein the RNA sample comprises RNA derived from biological materials.

6. The method of claim 1, wherein the DNA probe comprises a first nucleotide-based bar code and a second nucleotide-based bar code.

7. The method of claim 1, wherein said DNA probe comprises a detection sequence.

8. The method of claim 7, wherein the detection sequence is part of one of the signature sequences, between the signature sequences, or both.

9. The method of claim 1 further comprising, prior to step (a),
(i) bringing into contact the RNA sample and a set of subtraction DNA probes, wherein the subtraction DNA probes in the set collectively comprise sequences complementary non-target RNA molecules to be removed from the sample, and
(ii) separating subtraction DNA probes hybridized to non-target RNA molecules from the sample.

10. The method of claim 1, wherein the DNA probes hybridized to target RNA molecules are separated from the RNA sample using a physical property of RNA/DNA hybrids, a specific binding agent specific for RNA/DNA hybrids, an enzymatic agent specific for RNA/DNA hybrids, or a combination.

11. The method of claim 1, wherein detecting one or more of the DNA probes is accomplished by sequencing one or more of said DNA probes, and is accomplished by Solexa™ sequencing, by SOLiD™ sequencing, using Illumina® Genome Analyzer™, using 454™, or a combination.

12. A set of DNA probes for detecting target RNA, which comprises DNA probes that comprise a first signature sequence, a target complement sequence, a second signature sequence, and at least one nucleotide bar code, wherein the target complement sequence is complementary to sequence in a target RNA molecule.

13. The set of claim 12, wherein each of a plurality of the DNA probes in the set is for a different target RNA molecule wherein each of the DNA probes for a different target RNA molecule has a different nucleotide-based bar code.

14. The set of claim 13 comprising at least 100 different target DNA probes.

15. The set claim 12, wherein the target complement sequence is disposed in the at least one of the target DNA probes between the first signature sequence and the second signature sequence, or
wherein the at least one nucleotide-based bar code is disposed in the at least one of the DNA probes between the first signature sequence and the second signature sequence.
